(19) United States
(12) Patent Application Publication
(10) Pub. No.: US 2015/0128503 A1
(43) Pub. Date: May 14, 2015

(54) UNIT FOR PREVENTING BODY PART OF USER FROM BEING CAUGHT IN DOOR

(71) Applicant: WimKorea Co., Ltd., Gangwon-do (KR)

(72) Inventor: Seung Hyun Roh, Gangwon-do (KR)

(21) Appl. No.: 14/400,434

(22) PCT Filed: May 10, 2013
(86) PCT No.: PCT/KR2013/004147

§ 371 Date: Nov. 11, 2014

(30) Foreign Application Priority Data
May 11, 2012 (KR) 10-2012-0050216

(51) Int. Cl. E06B 7/36

(52) U.S. Cl. CPC E06B 7/362; E06B 7/367; E06B 2007/365
USPC 49/462

(57) ABSTRACT

The present invention relates to a unit for preventing a body part of a user from being caught. The prevention unit according to the present invention is to be coupled to a door and to a door frame, a floor hinge being connected to the lower surface of the door and the upper surface of the door being hinged onto a horizontal frame of the door frame such that the door can rotate about a hinge shaft, the door frame having the horizontal frame and a pair of vertical frames fixed to a wall. The prevention unit comprises: a unit for preventing a body part of a user from being caught in a door frame, the unit for preventing a body part of a user from being caught in a door frame having a door frame contact surface coupled to the vertical frame of the door frame and having a first concave curved surface having a first radius of curvature, the unit for preventing a body part of a user from being caught in a door frame having a cylindrical shape having a triangular cross-section or a quadrangular cross-section having at least one concave side, the unit for preventing a body part of a user from being caught in a door frame being coupled to the door frame such that the first concave curved surface faces the side surface of the door when the door rotates; and a unit for preventing a body part of a user from being caught in a door, the unit for preventing a body part of a user from being caught in a door having a door contact surface coupled to the edge of the front or rear surface of the door and having a first convex curved surface having a second radius of curvature smaller than the first radius of curvature, the unit for preventing a body part of a user from being caught in a door having a cylindrical shape having a triangular cross-section or a quadrangular cross-section having at least one convex side, the unit for preventing a body part of a user from being caught in a door being coupled to the door such that the vertical frame faces the first convex curved surface when the door rotates. According to the present invention, a body part of a user can be prevented from being caught in a door frame or a door, thus preventing or minimizing accidents and preventing or minimizing the waste of energy leaking through the space between the door and the door frame. Further, the prevention unit of the present invention is advantageous in that it can be coupled to all types of doors having various rotational axes or rotation radii in response to variations in the rotational axis of the door or to variations in the rotation radius of the door.

### FIELD AND BACKGROUND OF THE INVENTION

The present invention relates to a unit for preventing a body part of a user from being caught, and more particularly to a unit for preventing a body part of a user from being caught, which is capable of preventing accidents in which a finger or a part of the body of the user or another person is caught between the edge of the door and the inner surface of the door frame when a door is opened or closed, and to the door including the unit.

Generally, variously types of doors are installed in the entrance of a building or in the building. The doors are made of transparent and tempered glass having excellent durability in such a manner as to highlight the clean and elegant appearance of the building and to allow natural light to transmit through the front door.

FIG. 1 shows a structure of a general tempered glass door.

As shown in FIG. 1, the door includes a glass material 18 made of tempered glass, and a framework 12 of the door which is mounted on the upper and lower portions of the glass material 18 respectively. One side of each of the upper and lower portions of the framework 12 of the door is rotatably coupled to a hinge 16 of a door frame 14. The glass material 18 rotates about the hinge 16, so that the door 10 is opened and closed.

When the door 10 is opened and closed, a body part, for example, a finger, etc., of a person is caught between the glass material 18 and the door frame 14, and injury frequently occurs.

Even when the door 10 is in a closed state, a certain gap is formed between the glass material 18 and the door frame 14 for the purpose of smooth rotation of the door 10. Therefore, when the glass material 18 is rotated in a state where a body part, especially, a finger, etc., is caught in the gap, a big accident may occur. Also, due to the gap formed between the door and the door frame after the door is installed, heating and cooling do not work well and energy waste is caused.

Meanwhile, regarding a common door, a hinge shaft functioning as the center of the rotation of the door, is different according to the size or manufacturer of the door. Although a member which has a specific size and prevents being caught is provided, the variation of the rotation radius of the door causes the gap between the door and the door frame to become larger or smaller, so that the door is difficult to rotate.

### SUMMARY OF THE INVENTION

### Technical Problem

Therefore, one objective of the present invention is to provide the unit for preventing from being caught, which is capable of overcoming the above problems.

Another objective of the present invention is to provide the unit for preventing from being caught, which is capable of preventing or minimizing accidents by preventing a body part from being caught between the door frame and the door.

Further another objective of the present invention is to provide the unit for preventing from being caught, which is capable of preventing or minimizing the waste of energy leaking through the gap between the door and the door frame.

Yet another objective of the present invention is to provide the unit for preventing from being caught, which is coupled in response to the variation of the rotational axis of the door or to the variation of the rotation radius of the door.

### Technical Solution

According to the embodiments of the present invention for the purpose of overcoming some of the above-mentioned technical problems, a unit for preventing a body part of a user from being caught is coupled to a door and a door frame. The door has a structure in which a floor hinge is connected to the lower surface of the door and the upper surface of the door is hinged onto a horizontal frame of the door frame such that the door rotates about a hinge shaft. The door frame has the horizontal frame and the pair of vertical frames fixed to a wall. The unit for preventing a body part of a user from being caught includes: a unit for preventing a body part of a user from being caught in a door frame and a unit for preventing a body part of a user from being caught in a door. The unit for preventing a body part of a user from being caught in a door frame includes: a door frame contact surface which is fixed and coupled to the vertical frame of the door frame; a first concave curved surface which has a first radius of curvature; and a cylindrical shape which has a triangular cross-section or a quadrangular cross-section having at least one concave side, so that the unit for preventing a body part of a user from being caught in a door frame is coupled such that the first concave curved surface faces a side surface of the door when the door rotates. The unit for preventing a body part of a user from being caught in a door includes: a door contact surface which is fixed and coupled to an edge of a front side or rear side of the door; a first convex curved surface which has a second radius of curvature less than the first radius of curvature; and a cylindrical shape which has a triangular cross-section or a quadrangular cross-section having at least one convex side, so that the unit for preventing a body part of a user from being caught in a door is coupled such that the vertical frame faces the first convex curved surface when the door rotates.

The first radius of curvature may be the same as or larger by a certain amount than a minimum distance from the hinge shaft to the vertical frame. The second radius of curvature may be the same as or smaller by a certain amount than a rotation radius of the door which rotates about the hinge shaft.

When the rotation radius of the door is changed by changing the hinge shaft, the first radius of curvature and the second radius of curvature may become larger or smaller in response to the change of the hinge shaft or the change of the rotation radius of the door.

The unit for preventing a body part of a user from being caught may further include a first additional door frame unit which is additionally coupled to the unit for preventing a body part of a user from being caught in a door frame when the hinge shaft is moved and the rotation radius of the door becomes smaller. The first additional door frame unit may include a first concave curved surface contacting surface and a second concave curved surface. The first concave curved surface contacting surface may have a convex curved surface with the first radius of curvature such that the first additional door frame unit contacts and is coupled to the whole or partial first concave curved surface. The second concave curved surface may have a third radius of curvature less than the first radius of curvature. The first additional door frame unit may have a cylindrical shape having a triangular cross-section or a quadrangular cross-section having one concave side and one convex side.

The first concave curved surface contacting surface may include a fitting protrusion and the first concave curved surface may include a fitting recess to which the fitting protrusion is fitted and coupled, so that the first concave curved surface contacting surface may be fitted and coupled to the first concave curved surface, or the first concave curved surface contacting surface and the first concave curved surface may be adhered to each other by using an adhesive material.

The unit for preventing a body part of a user from being caught may further include a second additional door frame unit which is to be additionally coupled to the first additional door frame unit when the hinge shaft is moved and the rotation radius of the door becomes smaller. The second additional door frame unit may include a second concave curved surface contacting surface and a third concave curved surface and may have a cylindrical shape having a triangular cross-section or a quadrangular cross-section having one concave side and one convex side. The second concave curved surface contacting surface may have a convex curved surface with the third radius of curvature such that the second additional door frame unit contacts and is coupled to the whole or partial second concave curved surface. The third concave curved surface may have a fourth radius of curvature less than the third radius of curvature. The second concave curved surface contacting surface may include a fitting protrusion and the second concave curved surface may include a fitting recess to which the fitting protrusion is fitted and coupled, so that the second concave curved surface contacting surface is fitted and coupled to the second concave curved surface, or the second concave curved surface contacting surface and the second concave curved surface are adhered to each other by using an adhesive material.

The unit for preventing a body part of a user from being caught may further include a first additional door unit which is additionally coupled to the unit for preventing a body part of a user from being caught in a door when the hinge shaft is moved and the rotation radius of the door becomes larger. The first additional door unit may include a first convex curved surface contacting surface and a second convex curved surface. The first convex curved surface contacting surface may have a concave curved surface with the second radius of curvature such that the first additional door unit contacts and is coupled to the whole or partial first convex curved surface. The second convex curved surface may have a fifth radius of curvature larger than the second radius of curvature. The first additional door unit may have a cylindrical shape having a triangular cross-section or a quadrangular cross-section having one convex side and one concave side.

The first convex curved surface contacting surface may include a fitting protrusion and the first convex curved surface may include a fitting recess to which the fitting protrusion is fitted and coupled, so that the first convex curved surface contacting surface is fitted and coupled to the first convex curved surface, or the first convex curved surface contacting surface and the first convex curved surface are adhered to each other by using an adhesive material.

The unit for preventing a body part of a user from being caught may further include a second additional door unit which is additionally coupled to the first additional door unit when the hinge shaft is moved and the rotation radius of the door becomes larger. The second additional door unit may include a second convex curved surface contacting surface and a third convex curved surface and may have a cylindrical shape having a triangular cross-section or a quadrangular cross-section having one convex side and one concave side. The second convex curved surface contacting surface may have a concaved curved surface with the fifth radius of curvature such that the second additional door unit contacts and is coupled to the whole or partial second convex curved surface. The third convex curved surface may have a sixth radius of curvature larger the fifth radius of curvature. The second convex curved surface contacting surface may include a fitting protrusion and the second convex curved surface may include a fitting recess to which the fitting protrusion is fitted and coupled, so that the second convex curved surface contacting surface is fitted and coupled to the second convex curved surface, or the second convex curved surface contacting surface and the second convex curved surface are adhered to each other by using an adhesive material.

According to the embodiments of the present invention for the purpose of overcoming some of the above-mentioned technical problems, a unit for preventing a body part of a user from being caught is coupled to a door and a door frame. The door has a structure in which a floor hinge is connected to the lower surface of the door and the upper surface of the door is hinged onto a horizontal frame of the door frame such that the door rotates about a hinge shaft. The door frame has the horizontal frame and the pair of vertical frames fixed to a wall. The unit for preventing a body part of a user from being caught includes: a unit for preventing a body part of a user from being caught in a door frame and a unit for preventing a body part of a user from being caught in a door. The unit for preventing a body part of a user from being caught in a door frame includes: a door frame contact member which has a door frame contact surface to be coupled to the vertical frame of the door frame; a concave member which has a changeable concave curved surface having a curvature which is wholly or partially changeable; a first additional member which has a first additional surface; an integral cylindrical shape which has a first inner space and a triangular cross-section or a quadrangular cross-section having at least one concave side; and at least one first curvature adjusting member which is provided in the first inner space in order to change the curvature of the entire or partial changeable concave curved surface when the unit for preventing a body part of a user from being caught in a door frame is applied to a door having a different hinge shaft. The unit for preventing a body part of a user from being caught in a door includes: a door contact member which has a door contact surface to be coupled to an edge of a front side or rear side of the door; a convex member which has a changeable convex curved surface having a curvature which is wholly or partially changeable; a second additional member which has a second additional surface; an integral cylindrical shape which has a second inner space and a triangular cross-section or a quadrangular cross-section having at least one convex side; and at least one second curvature adjusting member which is provided in the second inner space in order to change the curvature of the entire or partial changeable convex curved surface when the unit for preventing a body part of a user from being caught in a door frame is applied to a door having a different hinge shaft.

The door frame contact member, the concave member, the first additional member, the door contact member, the convex member and the second additional member may be made of a soft flexible material. Otherwise, the door frame contact member and the door contact member may be made of a hard material, and the concave member, the first additional member, the convex member and the second additional member may be made of a soft material.

The at least one first curvature adjusting member may include: a first protrusion which is formed on an inner surface of the door frame contact member forming the first inner space and has a first screw hole formed therein; a second protrusion which is formed on the inner surface of the door frame contact member, is spaced apart from the first protrusion by a certain distance, and has a second screw hole formed therein; a first coupling recess which faces the inner surface of the door frame contact member and is formed within the vicinity of a vertex where the concave member meets the first additional member; a first inner adjusting member of which one end has a first coupling protrusion to be coupled to the first coupling recess and of which the other end has a third screw hole and is inserted between the first protrusion and the second protrusion, the first inner adjusting member being made of a hard inflexible material; and a first adjusting screw which passes through the first additional member and is inserted into the first screw hole, the second screw hole and the third screw hole. The other end of the first inner adjusting member is moved between the first protrusion and the second protrusion by tightening or loosing the first adjusting screw, in response to this, the one end of the first inner adjusting member moves in the opposite direction to the movement direction of the other end, so that the curvature of the changeable concave curved surface is adjusted.

The at least one second curvature adjusting member may include: a third protrusion which is formed on an inner surface of the door contact member forming the second inner space and has a fourth screw hole formed therein; a fourth protrusion which is formed on the inner surface of the door contact member, is spaced apart from the third protrusion by a certain distance, and has a fifth screw hole formed therein; a second coupling recess which faces the inner surface of the door contact member and is formed within the vicinity of a vertex where the convex member meets the second additional member; a second inner adjusting member of which one end has a second coupling protrusion to be coupled to the second coupling recess and of which the other end has a sixth screw hole and is inserted between the third protrusion and the fourth protrusion, the second inner adjusting member being made of a hard inflexible material; and a second adjusting screw which passes through the second additional surface and is inserted into the fourth screw hole, the fifth screw hole and the sixth screw hole. The other end of the second inner adjusting member is moved between the third protrusion and the fourth protrusion by tightening or loosing the second adjusting screw, in response to this, the one end of the second inner adjusting member moves in the opposite direction to the movement direction of the other end, so that the curvature of the changeable concave curved surface is adjusted.

A portion of the concave member and a portion of the first additional member may a corrugated structure having an elasticity and may become elastic by tightening and loosing the first adjusting screw.

An elastic spring may be further provided between the first protrusion and the first inner adjusting member or between the second protrusion and the first inner adjusting member.

A portion of the convex member and a portion of the second additional surface may have a corrugated structure having an elasticity and may become elastic by tightening and loosing the second adjusting screw.

An elastic spring may be further provided between the third protrusion and the second inner adjusting member or between the fourth protrusion and the second inner adjusting member.

### Advantageous Effects

Through the unit for preventing from being caught according to the present invention, it is possible to prevent or minimize accidents by preventing a body part from being caught between the door frame and the door, and to prevent or minimize the waste of energy leaking through the gap between the door and the door frame. It is also possible to couple the unit to all types of doors having various rotational axes or rotation radii in response to the variation of the rotational axis of the door or to the variation of the rotation radius of the door.

### BRIEF DESCRIPTION OF THE DRAWINGS

FIG. 1 shows a structure of a general tempered glass door;

FIGS. 2a-c are perspective views of a unit for preventing a body part of a user from being caught in a door frame in a unit for preventing a body part from being caught in accordance with a first embodiment of the present invention;

FIGS. 3a-c are perspective views of a unit for preventing a body part of a user from being caught in a door in the unit for preventing a body part from being caught in accordance with the first embodiment of the present invention;

FIGS. 4a-b, 5a-b and 6a-b are views showing examples in which the prevention unit according to the first embodiment of the present invention is applied to doors having various rotation radii;

FIGS. 7 and 8 are a perspective view and a cross sectional view respectively showing a unit for preventing a body part of a user from being caught in a door frame in a unit for preventing a body part from being caught in accordance with a second embodiment of the present invention;

FIGS. 9 and 10 are a perspective view and a cross sectional view respectively showing a unit for preventing a body part of a user from being caught in a door in the unit for preventing a body part from being caught in accordance with the second embodiment of the present invention;

FIGS. 11a-b, 12a-b, 13a-b, 14 and 15 are views showing examples in which the prevention unit according to the second embodiment of the present invention is applied to doors having various rotation radii;

FIGS. 16 and 17 are a perspective view and a cross sectional view respectively showing a unit for preventing a body part of a user from being caught in a door frame in a unit for preventing a body part from being caught in accordance with a third embodiment of the present invention;

FIGS. 18 and 19 are a perspective view and a cross sectional view respectively showing a unit for preventing a body part of a user from being caught in a door in the unit for preventing a body part from being caught in accordance with the third embodiment of the present invention; and

FIGS. 20, 21 and 22 are views showing examples in which the prevention unit according to the third embodiment of the present invention is applied to doors having various rotation radii.

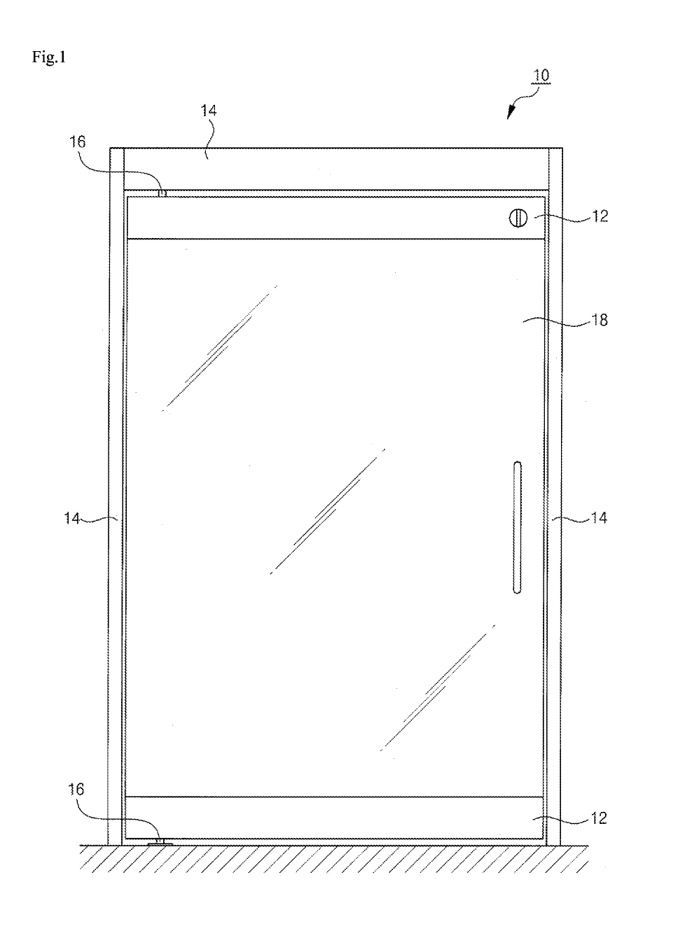

### DESCRIPTION OF SPECIFIC EMBODIMENTS OF THE INVENTION

Hereafter, an embodiment of the present invention will be described in detail with reference to the accompanying drawings with the intention of providing a person having ordinary skill in the art with thorough understanding of the present invention without any intention.

A unit for preventing a body part from being caught in accordance with the embodiments of the present invention is intended to be fixed and coupled to a door frame and a door. The door has a structure in which a floor hinge is connected to the lower surface of the door and the upper surface of the door is hinged onto the horizontal frame of the door frame such that the door can rotate about a hinge shaft. The door frame has a structure having the horizontal frame and a pair of vertical frames fixed to a wall. That is, the prevention unit according to the embodiments of the present invention can be applied to all types of doors and door frames having the structure in which the door can rotate about the hinge shaft provided in the upper and lower portions thereof.

The unit for preventing a body part of a user from being caught in accordance with the embodiments of the present invention may include a unit for preventing a body part of a user from being caught in a door frame and a unit for preventing a body part of a user from being caught in a door. The unit for preventing from being caught in a door is fixed and coupled to the door, and the unit for preventing from being caught in a door frame is fixed and coupled to the door frame.

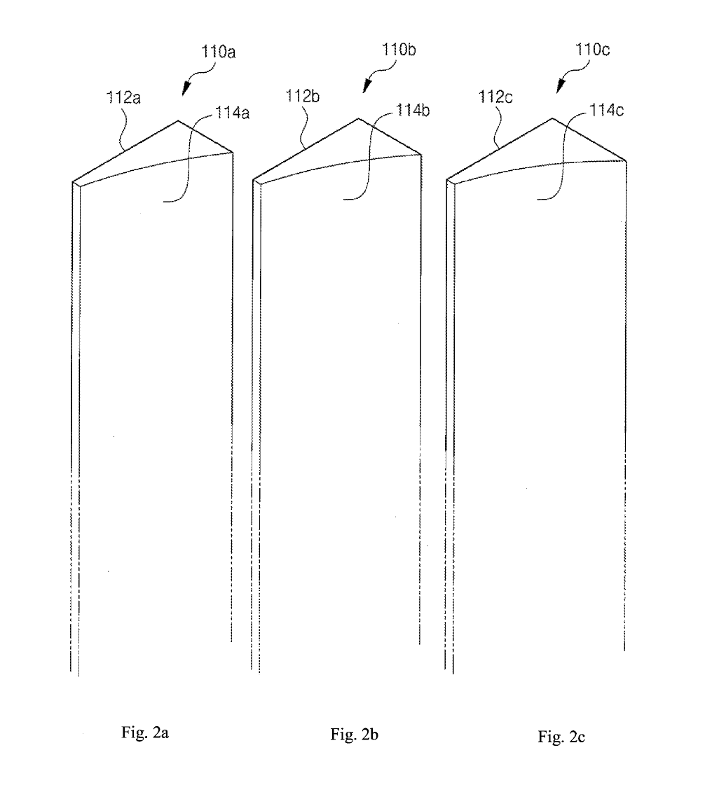

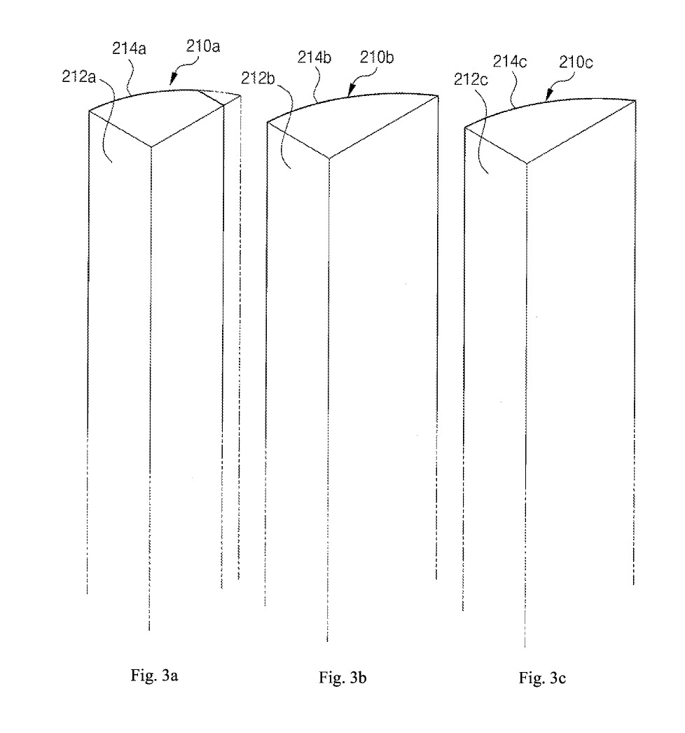

FIGS. 2a-c are perspective views of a unit for preventing a body part of a user from being caught in a door frame in a unit for preventing a body part from being caught in accordance with a first embodiment of the present invention. FIGS. 3a-c are perspective views of a unit for preventing a body part of a user from being caught in a door in the unit for preventing a body part from being caught in accordance with the first embodiment of the present invention.

As shown in FIGS. 2a-c, the unit 110a, 110b and 110c for preventing from being caught in a door frame includes a door frame contact surface 112a, 112b and 112c and a concave curved surface 114a, 114b and 114c and has a cylindrical shape having a triangular cross-section or a quadrangular cross-section having at least one concave side.

The unit 110a, 110b and 110c for preventing from being caught in a door frame is coupled such that the concave curved surface 114a, 114b and 114c faces the side surface of the door when the door rotates.

The door frame contact surface 112a, 112b and 112c is fixed and coupled to the vertical frame of the door frame. The door frame contact surface 112a, 112b and 112c may have a planar structure in response to the structure of the adhesion target surface of the vertical frame. The door frame contact surface 112a, 112b and 112c is adhered by using an adhesive material or a double-sided tape or the like.

The concave curved surface 114a, 114b and 114c has a concave shape having a certain radius of curvature. The radius of curvature of the concave curved surface 114a, 114b and 114c may be the same as or larger by a certain amount than the minimum distance from the hinge shaft (i.e., the rotation center of the door) of the door to the vertical frame.

The concave curved surface 114a, 114b and 114c may have various radii of curvature in response to the door having various hinge shafts.

That is, the unit for preventing a body part of a user from being caught may include a plurality of the units 110a, 110b and 110c for preventing from being caught in a door frame, which have the concave curved surfaces having various radii of curvature, such that the unit for preventing a body part of a user from being caught is coupled in response to the doors having various hinge shafts (or various rotation radii).

The unit 110a, 110b and 110c for preventing from being caught in a door frame may be made of a soft material which is entirely flexible. However, it is possible that the door frame contact surface 112a, 112b and 112c is made of a hard material and the other parts are made of a soft material, so that the unit 110a, 110b and 110c for preventing from being caught in a door frame can be easily adhered to the door frame. The soft material includes nitrile-butadiene rubber (NBR), a soft plastic material and the like.

The first unit 110a in FIG. 2a for preventing from being caught in a door frame may have the concave curved surface 114a with a radius of curvature corresponding to the door having a first rotation radius. The second unit 110b in FIG. 2b for preventing from being caught in a door frame may have the concave curved surface 114b with a radius of curvature corresponding to the door having a second rotation radius less than the first rotation radius.

The third unit 110c in FIG. 2c for preventing from being caught in a door frame may have the concave curved surface 114c with a radius of curvature corresponding to the door having a third rotation radius less than the second rotation radius. Therefore, the radius of curvature becomes smaller and the curvature becomes larger in the order of the concave curved surface 114a of the first unit 110a, the concave curved surface 114b of the second unit 110b and the concave curved surface 114c of the third unit 110c.

Besides, it is also possible to add at least one unit for preventing from being caught in a door frame, which has a concave curved surface changed in such a manner as to be coupled to a door having a rotation radius less than the third rotation radius or a rotation radius larger than the first rotation radius.

As shown in FIGS. 3a-c, the unit 210a, 210b and 210c for preventing from being caught in a door includes a door contact surface 212a, 212b and 212c and a convex curved surface 214a, 214b and 214c and has a cylindrical shape having a triangular cross-section or a quadrangular cross-section having at least one convex side.

The unit 210a, 210b and 210c for preventing from being caught in a door is coupled such that the vertical frame faces the convex curved surface when the door rotates.

The door contact surface 212a, 212b and 212c is fixed and coupled to the edge of the front side or rear side of the door. The door contact surface 212a, 212b and 212c may have a planar structure in response to the structure of the adhesion target surface of the door. The door contact surface 212a, 212b and 212c is adhered by using an adhesive material or a double-sided tape or the like.

The convex curved surface 214a, 214b and 214c has a convex shape having a certain radius of curvature. The convex curved surface 214a, 214b and 214c has a certain radius of curvature. The radius of curvature of the convex curved surface 214a, 214b and 214c may be the same as or smaller by a certain amount than the rotation radius of the door.

The convex curved surface 214a, 214b and 214c may have various radii of curvature in response to the door having various hinge shafts.

That is, the unit for preventing a body part of a user from being caught may include a plurality of the units 210a, 210b and 210c for preventing from being caught in a door, which have the convex curved surfaces 214a, 214b and 214c having various radii of curvature, such that the unit for preventing a body part of a user from being caught is coupled in response to the doors having various hinge shafts (or various rotation radii).

The unit 210a, 210b and 210c for preventing from being caught in a door may be made of a soft material which is entirely flexible. However, it is possible that the door contact surface 212a, 212b and 212c is made of a hard material and the other parts are made of a soft material, so that the unit 210a, 210b and 210c for preventing from being caught in a door can be easily adhered to the door. The soft material includes nitrile-butadiene rubber (NBR), a soft plastic material and the like.

The first unit 210a in FIG. 3a for preventing from being caught in a door may have the convex curved surface 214a with a radius of curvature corresponding to the door having the third rotation radius. The second unit 210b in FIG. 3b for preventing from being caught in a door may have the convex curved surface 214b with a radius of curvature corresponding to the door having the second rotation radius larger than the third rotation radius. The third unit 210c in FIG. 3c for preventing from being caught in a door may have the convex curved surface 214c with a radius of curvature corresponding to the door having the first rotation radius larger than the second rotation radius.

Therefore, the radius of curvature becomes larger and the curvature becomes smaller in the order of the convex curved surface 214a of the first unit 210a, the convex curved surface 214b of the second unit 210b and the convex curved surface 214c of the third unit 210c.

Besides, it is also possible to add at least one unit for preventing from being caught in a door, which has a convex curved surface changed in such a manner as to be coupled to a door having a rotation radius less than the third rotation radius or a rotation radius larger than the first rotation radius.

By adjusting the radius of curvature of the concave curved surface, the above-described unit for preventing from being caught in a door frame can be applied to both the vertical frame adjacent to the hinge shaft of the door and the vertical frame adjacent to the door handle. By adjusting the radius of curvature of the convex curved surface, the unit for preventing from being caught in a door can be applied to both the front and rear edges of the door, which are adjacent to the hinge shaft of the door and the front and rear edges of the door, which are adjacent to the door handle.

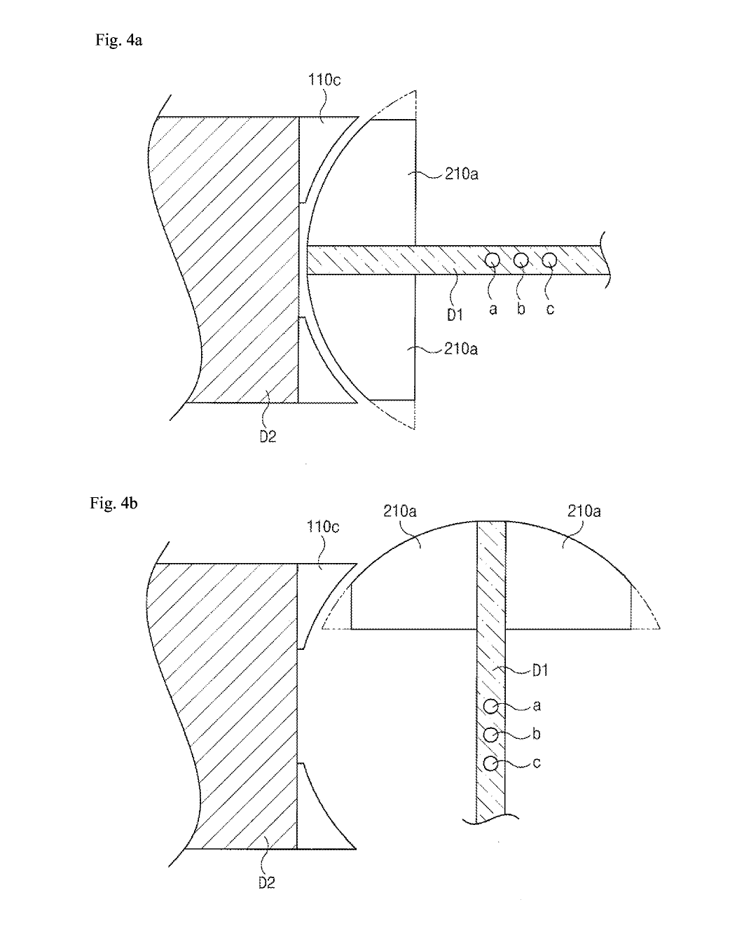

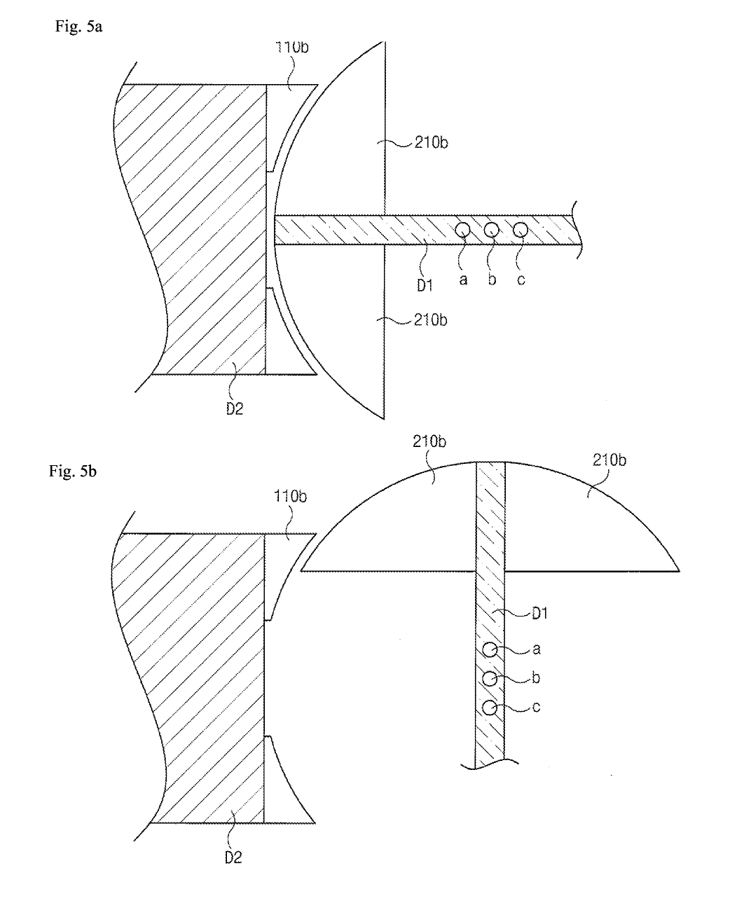

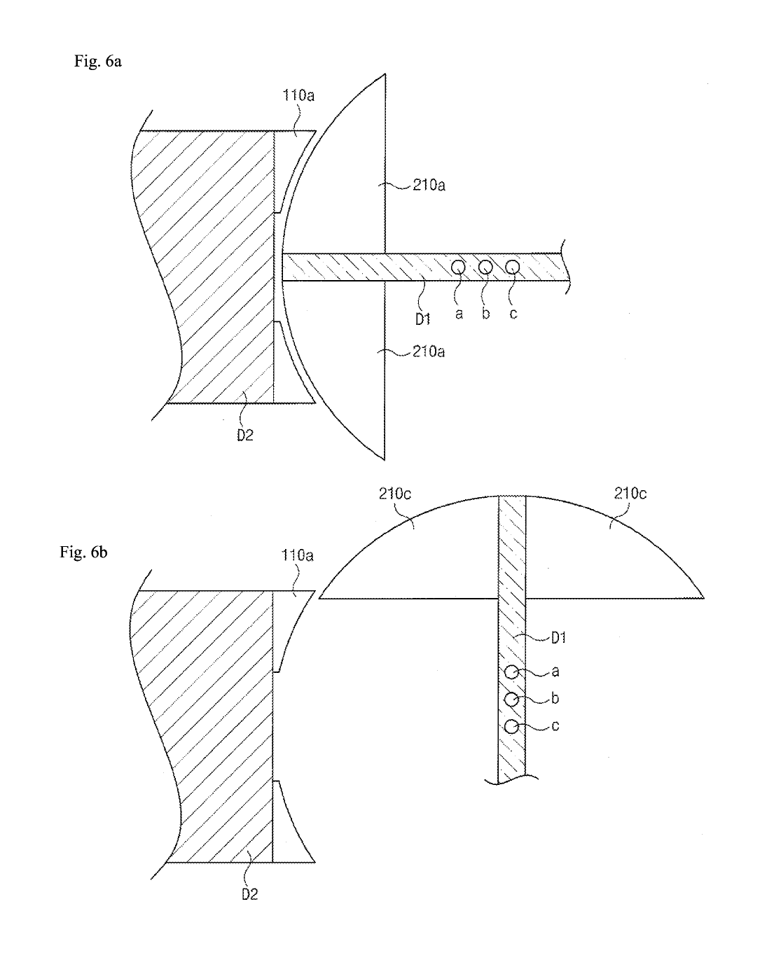

FIGS. 4a-b, 5a-b and 6a-b are views showing examples in which the prevention unit according to the first embodiment of the present invention is applied to doors D1 having various rotation radii. Here, only an example where the prevention unit according to the first embodiment of the present invention is applied to three doors D1 having different hinge shafts will be described. A case where the prevention unit according to the first embodiment of the present invention is coupled to the door frame D2 adjacent to the hinge shaft of the door D1 and the edge of the door D1 will be described and a case where the prevention unit according to the first embodiment of the present invention is coupled to the door frame D2 adjacent to the door handle of the door D1 and the edge of the door D1 will be omitted.

FIGS. 4a-b show an example in which the door D1 rotates about a first hinge shaft “a” and has the third rotation radius. FIGS. 5a-b show an example in which the door D1 rotates about a second hinge shaft “b” and has the second rotation radius. FIGS. 6a-b show an example in which the door D1 rotates about a third hinge shaft “c” and has the first rotation radius.

As shown in FIGS. 4a-b, when the door D1 rotates about the first hinge shaft “a” and has the third rotation radius, the third unit 110c having the smallest radius of curvature among the units 110a, 110b and 110c for preventing from being caught in a door frame is fixed to the vertical frame of the door frame D2, and the first unit 210a having the smallest radius of curvature among the units 210a, 210b and 210c for preventing from being caught in a door is fixed to the edge of the door D1. Here, the radius of curvature of the convex curved surface of the first unit 210a for preventing from being caught in a door should be less than that of the concave curved surface of the third unit 110c for preventing from being caught in a door frame. This intends to prevent the rotation of the door D1 from being interrupted by the prevention units 110c and 210a.

As shown in FIGS. 5a-b, when the door D1 rotates about the second hinge shaft “b” and has the second rotation radius, the second unit 110b having the intermediate radius of curvature among the units 110a, 110b and 110c for preventing from being caught in a door frame is fixed to the vertical frame of the door frame D2, and the second unit 210a having the intermediate radius of curvature among the units 210a, 210b and 210c for preventing from being caught in a door is fixed to the edge of the door D1. Here, the radius of curvature of the convex curved surface of the second unit 210b for preventing from being caught in a door should be less than that of the concave curved surface of the second unit 110b for preventing from being caught in a door frame. This intends to prevent the rotation of the door D1 from being interrupted by the prevention units 110b and 210b.

As shown in FIGS. 6a-b, when the door D1 rotates about the third hinge shaft “c” and has the first rotation radius, the first unit 110a having the largest radius of curvature among the units 110a, 110b and 110c for preventing from being caught in a door frame is fixed to the vertical frame of the door frame D2, and the third unit 210c having the largest radius of curvature among the units 210a, 210b and 210c for preventing from being caught in a door is fixed to the edge of the door D1. Here, the radius of curvature of the convex curved surface of the third unit 210c for preventing from being caught in a door should be less than that of the concave curved surface of the first unit 110a for preventing from being caught in a door frame. This intends to prevent the rotation of the door D1 from being interrupted by the prevention units 110a and 210c.

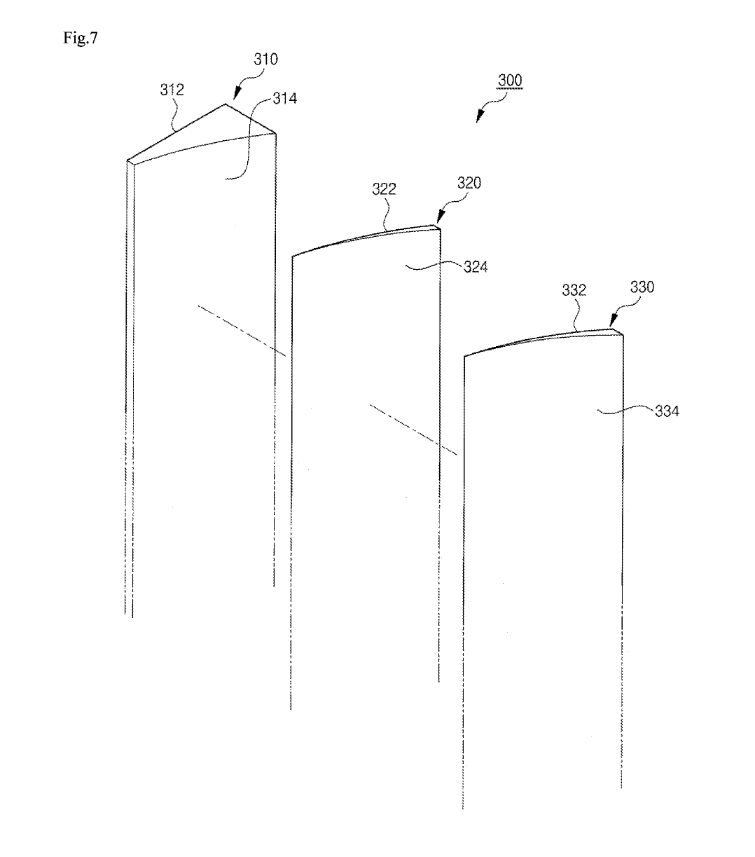

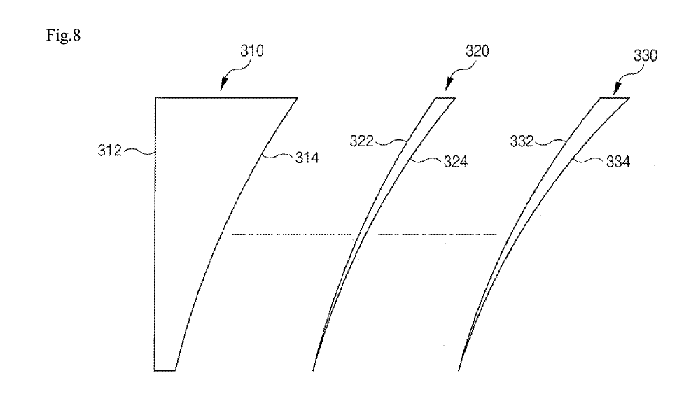

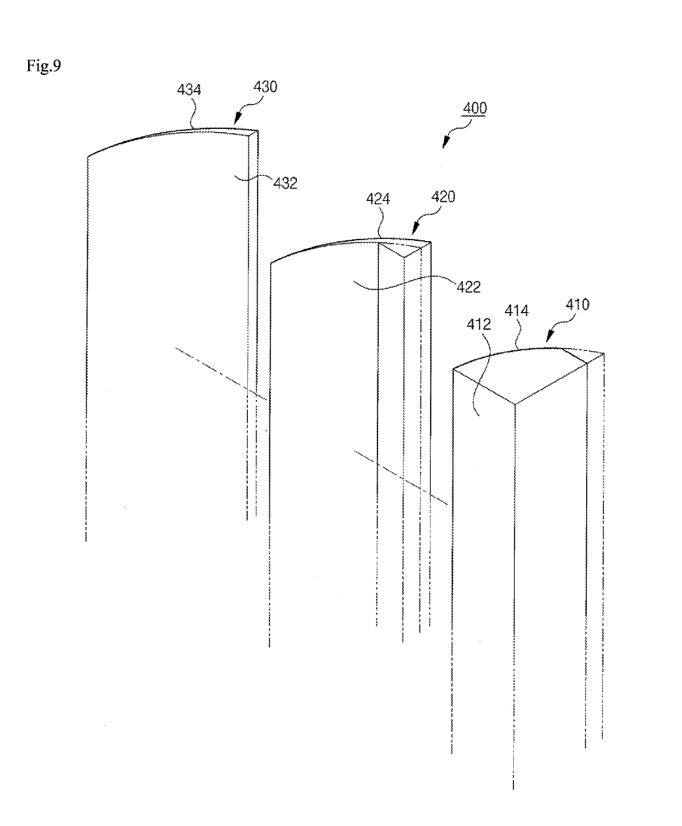

FIGS. 7 and 8 are a perspective view and a cross sectional view respectively showing a unit 300 for preventing a body part of a user from being caught in a door frame in a unit for preventing a body part from being caught in accordance with a second embodiment of the present invention. The unit 300 for preventing from being caught in a door frame may include a basic unit 310 for preventing from being caught in a door frame, a first additional door frame unit 320 and a second additional door frame unit 330. The lengths of the basic unit 310 for preventing from being caught in a door frame, the first additional door frame unit 320 and the second additional door frame unit 330 may correspond to the length of the vertical frame of the door frame or the door.

The basic unit 310 for preventing from being caught in a door frame includes a door frame contact surface 312 and a first concave curved surface 314 and has a cylindrical shape having a triangular cross-section or a quadrangular cross-section having at least one concave side. The basic unit 310 for preventing from being caught in a door frame is coupled such that the first concave curved surface 314 faces the side surface of the door when the door rotates.

The door frame contact surface 312 is fixed and coupled to the vertical frame of the door frame. The door frame contact surface 312 may have a planar structure in response to the structure of the adhesion target surface of the vertical frame. The door frame contact surface 312 is adhered by using an adhesive material or a double-sided tape or the like.

The first concave curved surface 314 has a first radius of curvature. The first radius of curvature may be the same as or larger by a certain amount than the minimum distance from the hinge shaft (i.e., the rotation center of the door) of the door to the vertical frame. Also, the first radius of curvature may correspond to the door having the largest rotation radius, e.g., the first rotation radius.

The first additional door frame unit 320 includes a first concave curved surface contacting surface 322 and a second concave curved surface 324. The first concave curved surface contacting surface 322 has a convex curved surface with the first radius of curvature such that the first additional door frame unit 320 contacts and is coupled to the whole or partial first concave curved surface 314. The second concave curved surface 324 has a third radius of curvature less than the first radius of curvature. The first additional door frame unit 320 has a cylindrical shape having a triangular cross-section or a quadrangular cross-section having one concave side and one convex side. When the door has the second rotation radius less than the first rotation radius, the first additional door frame unit 320 is additionally coupled to the basic unit 310 for preventing from being caught in a door frame. The third radius of curvature may correspond to the door having the second rotation radius.

Though not shown, the first concave curved surface contacting surface 322 may include a fitting protrusion and the first concave curved surface 314 may include a fitting recess to which the fitting protrusion is fitted and coupled. In this case, the fitting protrusion of the first concave curved surface contacting surface 322 is fitted in the fitting recess, so that the first concave curved surface contacting surface 322 is fitted and coupled to the first concave curved surface 314. Unlike this, the first concave curved surface contacting surface 322 and the first concave curved surface 314 can be adhered and coupled to each other by using an adhesive material or an adhesive tape.

The second additional door frame unit 330 may include a second concave curved surface contacting surface 332 and a third concave curved surface 334. The second concave curved surface contacting surface 332 has a convex curved surface with the third radius of curvature such that the second additional door frame unit 330 contacts and is coupled to the whole or partial second concave curved surface 324. The third concave curved surface 334 has a fourth radius of curvature less than the third radius of curvature. The second additional door frame unit 330 has a cylindrical shape having a triangular cross-section or a quadrangular cross-section having one concave side and one convex side.

When the door has the third rotation radius less than the second rotation radius, the second additional door frame unit 330 is additionally coupled to the basic unit 310 to which the first additional door frame unit 320 has been coupled. The fourth radius of curvature may correspond to the door having the third rotation radius less than the second rotation radius.

Though not shown, the second concave curved surface contacting surface 332 may include a fitting protrusion and the second concave curved surface 324 may include a fitting recess to which the fitting protrusion is fitted and coupled. In this case, the fitting protrusion of the second concave curved surface contacting surface 332 is fitted in the fitting recess, so that the second concave curved surface contacting surface 332 is fitted and coupled to the second concave curved surface 324. Unlike this, the second concave curved surface contacting surface 332 and the second concave curved surface 324 can be adhered and coupled to each other by using an adhesive material or an adhesive tape.

The basic unit 310 for preventing from being caught in a door frame, the first additional door frame unit 320 and the second additional door frame unit 330 may be made of a soft material which is entirely flexible. However, it is possible that the door frame contact surface 312 is made of a hard material and the other parts are made of a soft material, so that the basic unit 310 for preventing from being caught in a door frame, the first additional door frame unit 320 and the second additional door frame unit 330 can be easily adhered to the door frame. The soft material includes nitrile-butadiene rubber (NBR), a soft plastic material and the like.

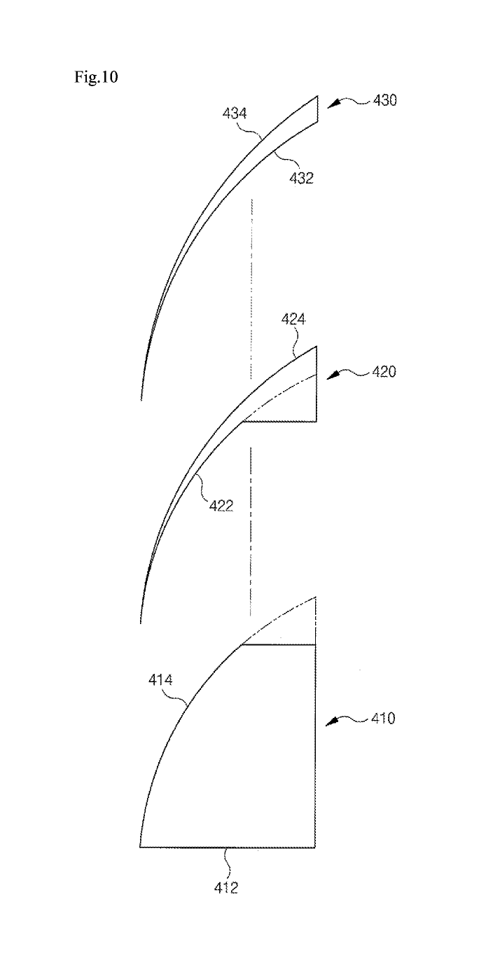

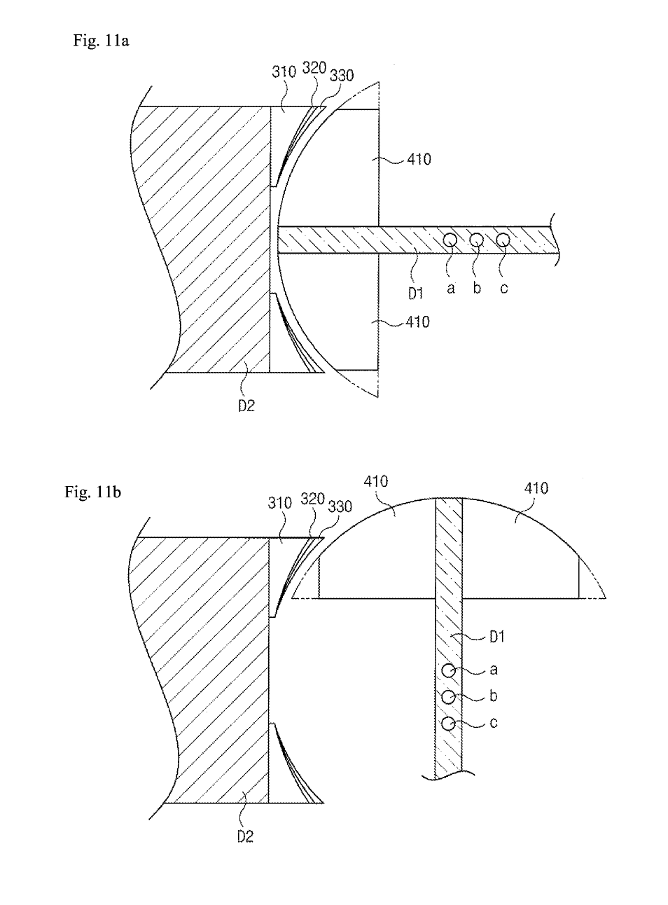

FIGS. 9 and 10 are a perspective view and a cross sectional view respectively showing a unit 400 for preventing a body part of a user from being caught in a door in the unit for preventing a body part from being caught in accordance with the second embodiment of the present invention. The unit 400 for preventing a body part of a user from being caught in a door may include a basic unit 410 for preventing from being caught in a door, a first additional door unit 420 and a second additional door unit 430.

The basic unit 410 for preventing from being caught in a door includes a door contact surface 412 and a first convex curved surface 414, and has a cylindrical shape having a triangular cross-section or a quadrangular cross-section having at least one convex side.

The basic unit 410 for preventing from being caught in a door is coupled to the front and rear edges of the door such that the vertical frame faces the convex curved surface when the door rotates.

The door contact surface 412 is fixed and coupled to the edge of the front side or rear side of the door. The door contact surface 412 may have a planar structure in response to the structure of the adhesion target surface of the door. The door contact surface 412 is adhered by using an adhesive material or a double-sided tape or the like.

The first convex curved surface 414 has a convex shape having a second radius of curvature less than the first radius of curvature. The radius of curvature of the first convex curved surface 414 may be the same as or smaller by a certain amount than the rotation radius of the door. Also, the second radius of curvature may correspond to the door having the smallest rotation radius, e.g., the third rotation radius.

The first additional door unit 420 includes a first convex curved surface contacting surface 422 and a second convex curved surface 424. The first convex curved surface contacting surface 422 has a concave curved surface with the second radius of curvature such that the first additional door unit 420 contacts and is coupled to the whole or partial first convex curved surface 414. The second convex curved surface 424 has a fifth radius of curvature larger than the second radius of curvature. The first additional door unit 420 has a cylindrical shape having a triangular cross-section or a quadrangular cross-section having one convex side and one concave side.

When the door has the second rotation radius larger than the third rotation radius, the first additional door unit 420 is additionally coupled to the basic unit 410 for preventing from being caught in a door. The fifth radius of curvature may correspond to the door having the second rotation radius.

Though not shown, the first convex curved surface contacting surface 422 may include a fitting protrusion and the first convex curved surface 414 may include a fitting recess to which the fitting protrusion is fitted and coupled. In this case, the fitting protrusion of the first convex curved surface contacting surface 422 is fitted in the fitting recess, so that the first convex curved surface contacting surface 422 is fitted and coupled to the first convex curved surface 414. Unlike this, the first convex curved surface contacting surface 422 and the first convex curved surface 414 can be adhered and coupled to each other by using an adhesive material or an adhesive tape.

The second additional door unit 430 may include a second convex curved surface contacting surface 432 and a third convex curved surface 434. The second convex curved surface contacting surface 432 has a concave curved surface with the fifth radius of curvature such that the second additional door unit 430 can be coupled to the whole or partial second convex curved surface 424. The third convex curved surface 434 has a sixth radius of curvature larger than the fifth radius of curvature. The second additional door unit 430 has a cylindrical shape having a triangular cross-section or a quadrangular cross-section having one convex side and one concave side.

When the door has the first rotation radius larger than the second rotation radius, the second additional door unit 430 is additionally coupled to the basic unit 410 to which the first additional door unit 420 has been coupled. The sixth radius of curvature may correspond to the door having the first rotation radius.

Though not shown, the second convex curved surface contacting surface 432 may include a fitting protrusion and the second convex curved surface 424 may include a fitting recess to which the fitting protrusion is fitted and coupled. In this case, the fitting protrusion of the second convex curved surface contacting surface 432 is fitted in the fitting recess, so that the second convex curved surface contacting surface 432 is fitted and coupled to the second convex curved surface 424. Unlike this, the second convex curved surface contacting surface 432 and the second convex curved surface 424 can be adhered and coupled to each other by using an adhesive material or an adhesive tape.

The basic unit 410 for preventing from being caught in a door, the first additional door unit 420 and the second additional door unit 430 may be made of a soft material which is entirely flexible. However, it is possible that the door contact surface 412 is made of a hard material and the other parts are made of a soft material, so that the basic unit 410 for preventing from being caught in a door, the first additional door unit 420 and the second additional door unit 430 can be easily adhered to the door. The soft material includes nitrile-butadiene rubber (NBR), a soft plastic material and the like.

As described above, according to the unit for preventing a body part from being caught in accordance with the second embodiment of the present invention, the additional units having various radii of curvature are coupled in response to the doors having various rotational axes, thereby making it possible to easily prevent a body part from being caught.

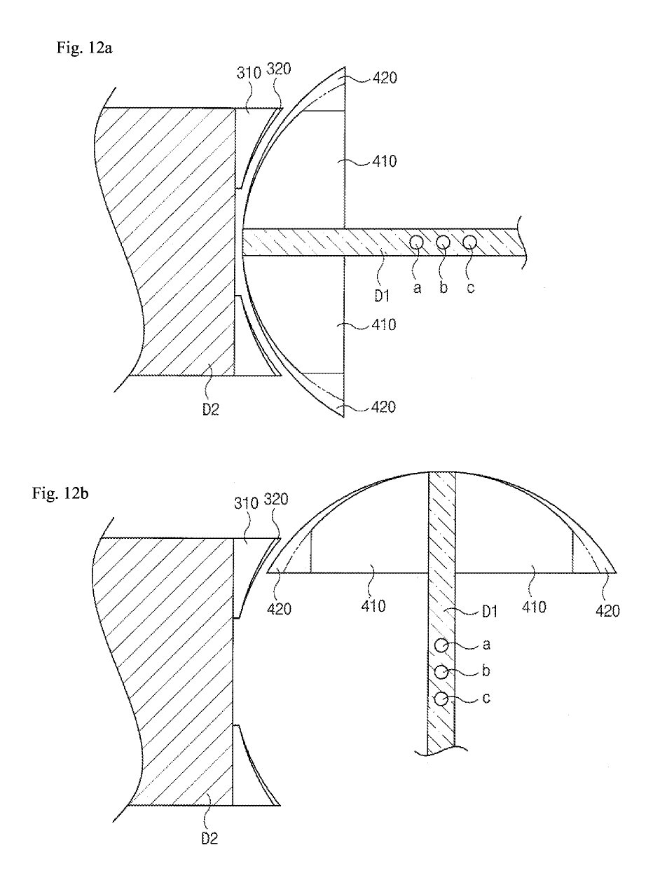

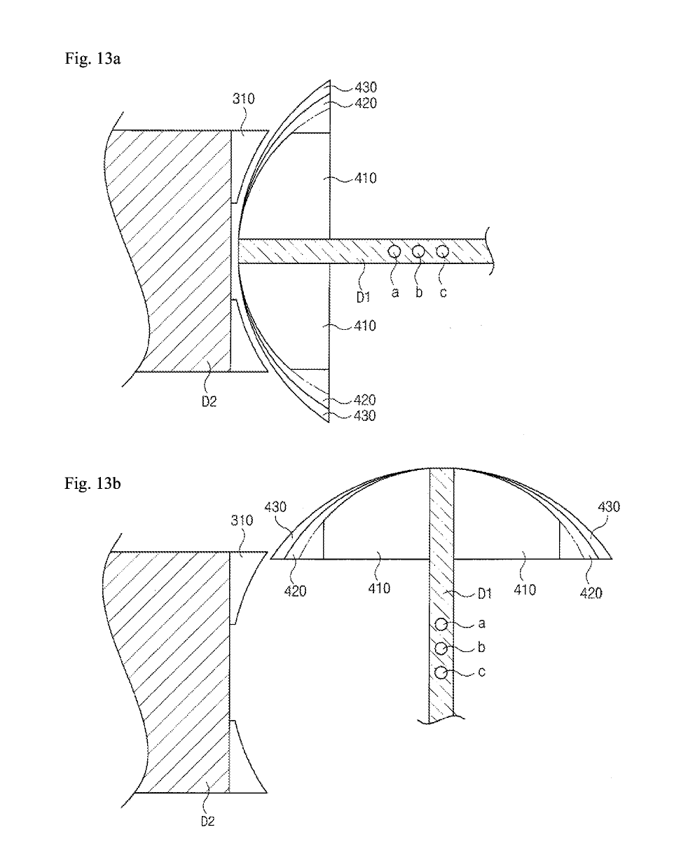

FIGS. 11a-b, 12a-b, 13a-b, 14 and 15 are views showing examples in which the prevention unit according to the second embodiment of the present invention is applied to doors D1 having various rotation radii. FIGS. 11a-b, 12a-b and 13a-b are cross sectional views. FIG. 14 is a perspective view of FIGS. 11a-b. FIG. 15 shows that the prevention units 410a and 310a have been also installed in the vicinity of the door handle.

Here, only an example where the prevention unit according to the second embodiment of the present invention is applied to three doors D1 having different hinge shafts will be described. A case where the prevention unit according to the second embodiment of the present invention is coupled to the door frame D2 adjacent to the hinge shaft of the door D1 and the edge of the door D1 will be described and a case where the prevention unit according to the second embodiment of the present invention is coupled to the door frame D2 adjacent to the door handle of the door D1 and the edge of the door D1 will be omitted.

FIGS. 11a-b show an example in which the door D1 rotates about the first hinge shaft “a” and has the third rotation radius. FIGS. 5a-b show an example in which the door D1 rotates about the second hinge shaft “b” and has the second rotation radius. FIGS. 6a-b show an example in which the door D1 rotates about the third hinge shaft “c” and has the first rotation radius. FIG. 14 is a perspective view of FIGS. 11a-b.

As shown in FIGS. 11a-b and 14, when the door D1 rotates about the first hinge shaft “a” and has the third rotation radius, the first additional door frame unit 320 and the second additional door frame unit 330 are coupled to the basic unit 310 for preventing from being caught in a door frame and are fixed to the vertical frame of the door frame D2, and only the basic unit 410 for preventing from being caught in a door is coupled and fixed to the door D1. Here, the second radius of curvature, i.e., the radius of curvature of the convex curved surface 414 of the basic unit 410 for preventing from being caught in a door should be less than the fourth radius of curvature, i.e., the radius of curvature of the concave curved surface 334 of the second additional door frame unit 330. This intends to prevent the rotation of the door D1 from being interrupted by the prevention units 310, 320, 330 and 410.

As shown in FIGS. 12a-b, when the door D1 rotates about the second hinge shaft “b” and has the second rotation radius, the first additional door frame unit 320 coupled to the basic unit 310 for preventing from being caught in a door frame and is fixed to the vertical frame of the door frame D2, and the first additional door unit 420 is coupled to the basic unit 410 for preventing from being caught in a door and is fixed to the door Dl.

Here, the fifth radius of curvature, i.e., the radius of curvature of the convex curved surface 424 of the first additional door unit 420 should be less than the third radius of curvature, i.e., the radius of curvature of the concave curved surface 324 of the first additional door frame unit 320. This intends to prevent the rotation of the door D1 from being interrupted by the prevention units 310, 320, 410 and 420.

As shown in FIGS. 13a-b, when the door D1 rotates about the third hinge shaft “c” and has the first rotation radius, only the basic unit 310 for preventing from being caught in a door frame is fixed to the vertical frame of the door frame D2, and the first additional door unit 420 and the second additional door unit 430 are sequentially coupled to the basic unit 410 for preventing from being caught in a door and are fixed to the door D1.

Here, the sixth radius of curvature, i.e., the radius of curvature of the convex curved surface 434 of the second additional door unit 430 should be less than the first radius of curvature, i.e., the radius of curvature of the concave curved surface 314 of the basic unit 310 for preventing from being caught in a door frame. This intends to prevent the rotation of the door D1 from being interrupted by the prevention units 310, 410, 420 and 430.

In the above-described unit for preventing from being caught in a door frame in accordance with the second embodiment of the present invention, it is possible to adjust the radius of curvature of the concave curved surface by adhering only the basic unit 310 for preventing from being caught in a door frame to both the vertical frame adjacent to the hinge shaft of the door and the vertical frame adjacent to the door handle or by adhering the additional door frame units 320 and 330 to the basic unit 310 for preventing from being caught in a door frame.

Also, in the unit 400 for preventing from being caught in a door, it is possible to adjust the radius of curvature of the convex curved surface by adhering only the basic unit 410 for preventing from being caught in a door to both the front and rear edges of the door, which are adjacent to the hinge shaft of the door and the front and rear edges of the door, which are adjacent to the door handle or by adhering the additional door units 420 and 430 to the basic unit 410 for preventing from being caught in a door.

That is, as shown in FIG. 15, the prevention units 410a and 310a can be installed in the vicinity of the door handle in accordance with the above-described principle.

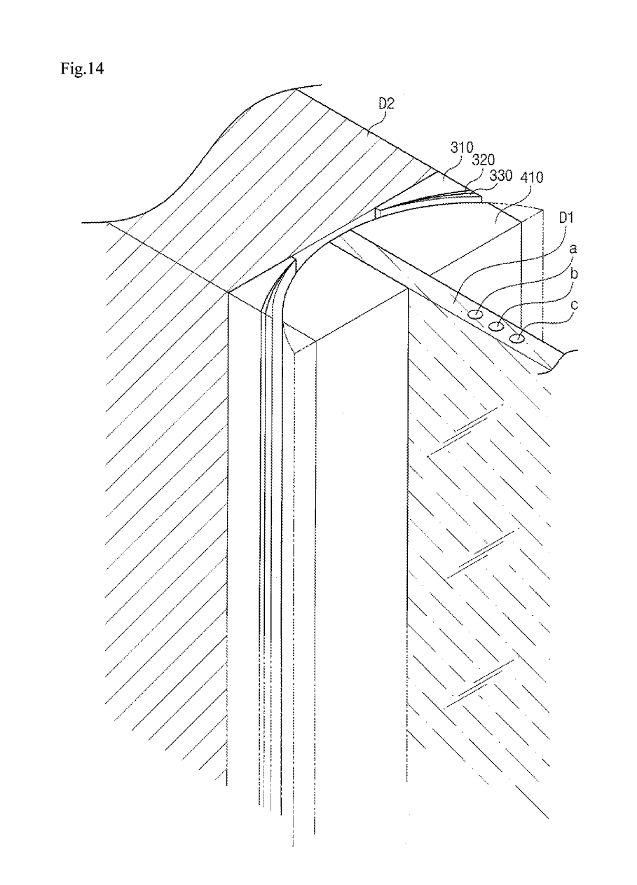

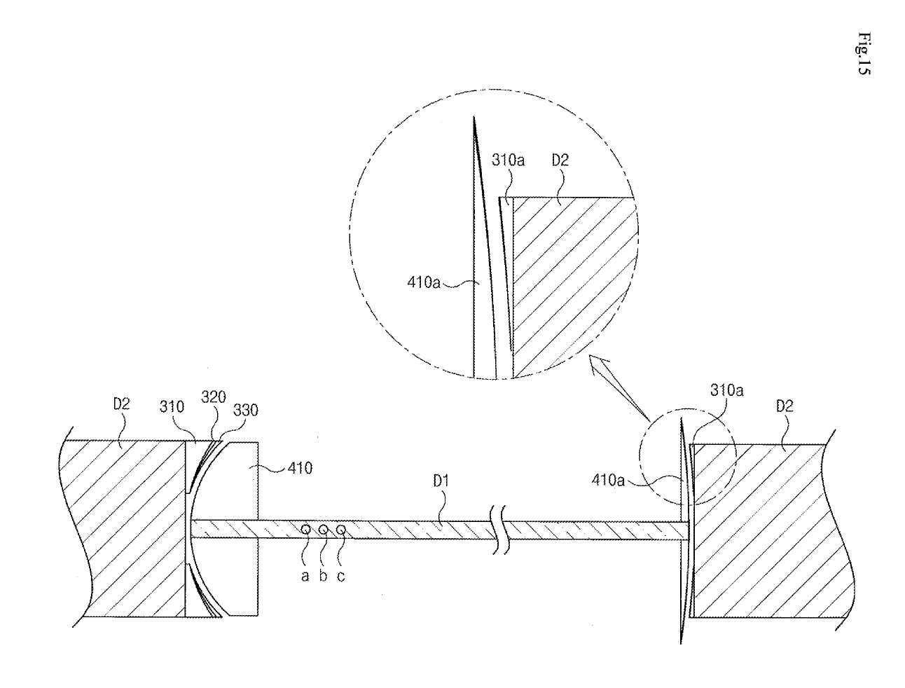

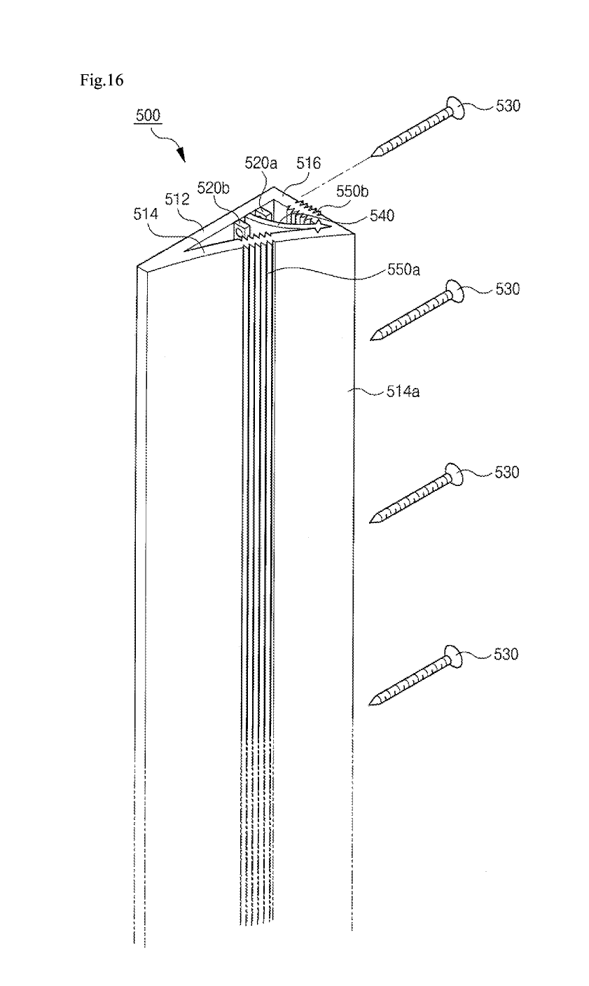

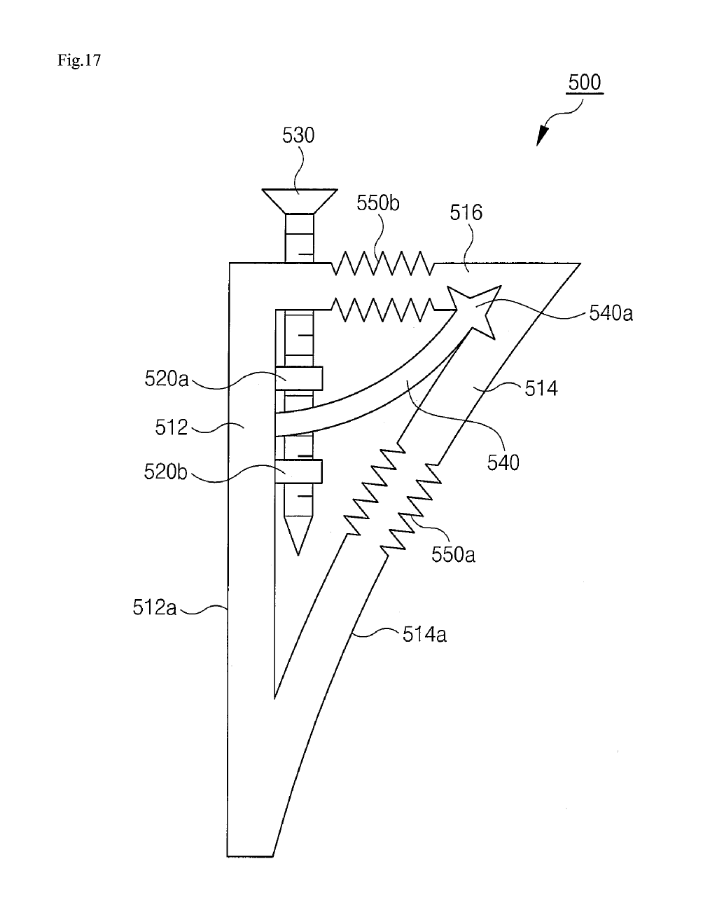

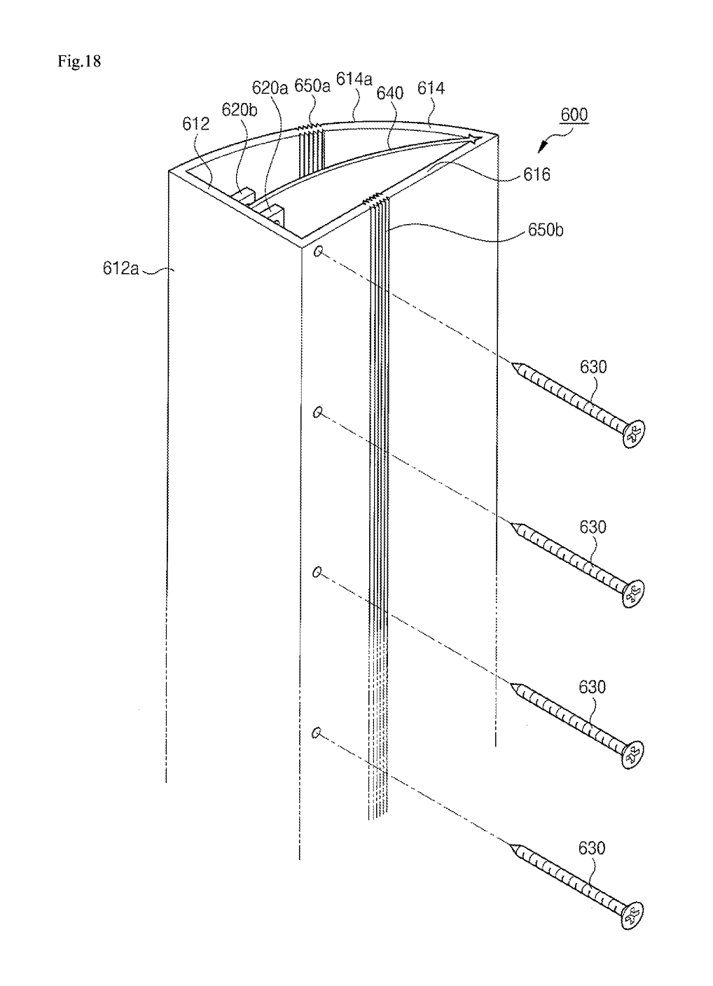

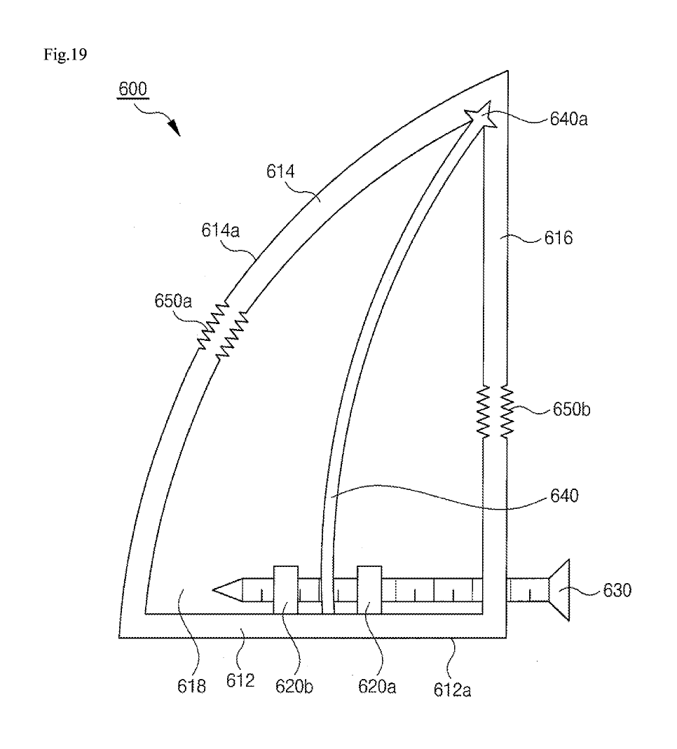

FIGS. 16 and 17 are a perspective view and a cross sectional view respectively showing a unit 500 for preventing a body part of a user from being caught in a door frame in a unit for preventing a body part from being caught in accordance with a third embodiment of the present invention. FIGS. 18 and 19 are a perspective view and a cross sectional view respectively showing a unit 600 for preventing a body part of a user from being caught in a door in the unit for preventing a body part from being caught in accordance with the third embodiment of the present invention.

The unit 500 for preventing from being caught in a door frame and the unit 600 for preventing from being caught in a door are coupled to the door and the door frame. The door has a structure in which the floor hinge is connected to the lower surface of the door and the upper surface of the door is hinged onto a horizontal frame of the door frame such that the door rotates about the hinge shaft. The door frame has the horizontal frame and the pair of vertical frames fixed to a wall.

As shown in FIGS. 16 and 17, the unit 500 for preventing from being caught in a door frame includes a door frame contact member 512, a concave member 514 and a first additional member 516 and has an integral cylindrical shape having a triangular cross-section or a quadrangular cross-section having at least one concave side. The unit 500 for preventing from being caught in a door frame has a hollow cylindrical shape having a first inner space 518. The first inner space 518 includes at least one first curvature adjusting member 520a, 520b, 530 and 540.

The door frame contact member 512 has a door frame contact surface 512a to be coupled to the vertical frame of the door frame. The door frame contact surface 512a is fixed and coupled to the vertical frame of the door frame. The door frame contact surface 512a may have a planar structure in response to the structure of the adhesion target surface of the vertical frame. The door frame contact surface 512a is adhered by using an adhesive material or a double-sided tape or the like.

The concave member 514 has a changeable concave curved surface 514a having a curvature which can be wholly or partially changed. The changeable concave curved surface 514a has basically a concave curved shape with a certain curvature and has a curvature which is wholly or partially changed by the at least one first curvature adjusting member 520a, 520b, 530 and 540. That is, the changeable concave curved surface 514a may be changed to have various curvatures in response to the door having various hinge shafts.

The unit 500 for preventing from being caught in a door frame is coupled such that the changeable concave curved surface 514a faces the side surface of the door when the door rotates.

The first additional member 516 is provided together with the door frame contact member 512 and the concave member 514 in order that the unit 500 for preventing from being caught in a door frame has a cylindrical shape having a triangular cross-section or a quadrangular cross-section having at least one concave side.

The first additional member 516, the door frame contact member 512 and the concave member 514 are integrally formed with each other, so that the unit 500 for preventing from being caught in a door frame has a cylindrical shape having the first inner space 518.

The first additional member 516, the door frame contact member 512 and the concave member 514 may be made of a soft flexible material. Additionally, for the purpose of easily adhering the unit 500 for preventing from being caught in a door frame to the door frame, the door frame contact member 512 may be made of a hard material and the first additional member 516 and the concave member 514 may be made of a soft material. The soft material includes nitrile-butadiene rubber (NBR), a soft plastic material and the like.

The at least one first curvature adjusting member 520a, 520b, 530 and 540 is provided in the first inner space 518 in order to change the curvature of the entire or partial changeable concave curved surface 514a when the prevention unit 500 is applied to a door having a different hinge shaft.

The at least one first curvature adjusting member 520a, 520b, 530 and 540 includes the first protrusion 520a and the second protrusion 520b. The first protrusion 520a is formed on the inner surface of the door frame contact member 512 forming the first inner space 518 and has a first screw hole formed therein. The second protrusion 520b is formed on the inner surface of the door frame contact member 512, is spaced apart from the first protrusion 520a by a certain distance, and has a second screw hole formed therein.

Also, the first curvature adjusting member 520a, 520b, 530 and 540 includes a first coupling recess (not shown) and the first inner adjusting member 540. The first coupling recess faces the inner surface of the door frame contact member 512 and is formed within the vicinity of a vertex where the concave member 514 meets the first additional member 516. A first coupling protrusion 540a to be coupled to the first coupling recess is formed on one end of the first inner adjusting member 540, and the other end of the first inner adjusting member 540 has a third screw hole (not shown) formed therein and is inserted between the first protrusion 520a and the second protrusion 520b. The first inner adjusting member 540 is made of a hard inflexible material.

The first curvature adjusting member 520a, 520b, 530 and 540 includes the first adjusting screw 530 which passes through the first additional member 516 and is inserted into the first screw hole, the second screw hole and the third screw hole.

It should be understood that the first adjusting screw 530 includes not only a common screw but also all kinds of adjustment means including a bolt, which can be tightened and loosen by rotation.

In the at least one first curvature adjusting member 520a, 520b, 530 and 540, the other end of the first inner adjusting member 540 is moved between the first protrusion 520a and the second protrusion 520b by tightening or loosing the first adjusting screw 530, in response to this, the one end of the first inner adjusting member 540 moves in the opposite direction to the movement direction of the other end. Accordingly, the curvature of the changeable concave curved surface 514a can be adjusted. This is because the first inner adjusting member 540 is made of a hard inflexible material.

In other words, if the other end of the first inner adjusting member 540 moves in a first direction, i.e., toward the first protrusion 520a from the second protrusion 520b by tightening or loosing the first adjusting screw 530, the one end of the first inner adjusting member 540 moves in a second direction which is opposite to the first direction. Accordingly, the changeable concave curved surface 514a becomes more concave, so that the curvature of the changeable concave curved surface 514a becomes larger.

On the contrary, if the other end of the first inner adjusting member 540 moves in the second direction, i.e., toward the second protrusion 520b from the first protrusion 520a, the one end of the first inner adjusting member 540 moves in the first direction which is opposite to the second direction. Accordingly, the changeable concave curved surface 514a becomes less concave, so that the curvature of the changeable concave curved surface 514a becomes smaller.

Therefore, since it becomes possible to adjust the curvature of the entire or partial changeable concave curved surface 514a by the first adjusting screw 530, the prevention unit 500 can be applied to all the doors having mutually different rotation radii due to the mutually different hinge shafts

In addition, a portion of the concave member 514 and a portion of the first additional member 516 have a corrugated structure 550a and 550b having an elasticity and become elastic by tightening and loosing the first adjusting screw 530. In this case, the curvature of the entire or partial changeable concave curved surface 514a may be more easily adjusted.

Also, an elastic spring (not shown) may be further provided between the first protrusion 520a and the first inner adjusting member 540 or between the second protrusion 520b and the first inner adjusting member 540.

As shown in FIGS. 18 and 19, the unit 600 for preventing from being caught in a door includes a door contact member 612, a convex member 614 and a second additional member 616 and has a cylindrical shape having an integral triangular cross-section at least one concave side or a quadrangular cross-section having at least one convex side. The unit 600 for preventing from being caught in a door has a hollow cylindrical shape having a second inner space 618. The second inner space 618 includes at least one second curvature adjusting member 620a, 620b, 630 and 640.

The door contact member 612 has a door contact surface 612a to be fixed and coupled to the edge of the front side or rear side of the door. The door contact surface 612a is fixed and coupled to the vertical frame of the door frame. The door contact surface 612a may have a planar structure in response to the structure of the adhesion target surface of the door. The door contact surface 612a is adhered by using an adhesive material or a double-sided tape or the like.

The convex member 614 has a changeable convex curved surface 614a having a curvature which can be wholly or partially changed. The changeable convex curved surface 614a has basically a convex curved shape with a certain curvature and has a curvature which is wholly or partially changed by the at least one second curvature adjusting member 620a, 620b, 630 and 640. That is, the changeable convex curved surface 614a may be changed to have various curvatures in response to the door having various hinge shafts.

The unit 600 for preventing from being caught in a door may be coupled such that the vertical frame faces the changeable convex curved surface 614a when the door rotates.

The second additional member 616 is provided together with the door contact member 612 and the convex member 614 in order that the unit 600 for preventing from being caught in a door has a cylindrical shape having a triangular cross-section or a quadrangular cross-section having at least one concave side.

The second additional member 616, the door contact member 612 and the convex member 614 are integrally formed with each other, so that the unit 600 for preventing from being caught in a door has a cylindrical shape having the second inner space 618.

The second additional member 616, the door contact member 612 and the convex member 614 may be made of a soft flexible material. Additionally, for the purpose of easily adhering the unit 600 for preventing from being caught in a door, the door contact member 612 may be made of a hard material and the second additional member 616 and the convex member 614 may be made of a soft material. The soft material includes nitrile-butadiene rubber (NBR), a soft plastic material and the like.

The at least one second curvature adjusting member 620a, 620b, 630 and 640 is provided in the second inner space 618 in order to change the curvature of the entire or partial changeable convex curved surface 614a when the prevention unit 600 is applied to a door having a different hinge shaft.

The at least one second curvature adjusting member 620a, 620b, 630 and 640 includes the third protrusion 620a and the fourth protrusion 620b. The third protrusion 620a is formed on the inner surface of the door contact member 612 forming the second inner space 618 and has a fourth screw hole formed therein. The fourth protrusion 620b is formed on the inner surface of the door contact member 612, is spaced apart from the third protrusion 620a by a certain distance, and has a fifth screw hole formed therein.

Also, the second curvature adjusting member 620a, 620b, 630 and 640 includes a second coupling recess (not shown) and the second inner adjusting member 640. The second coupling recess faces the inner surface of the door contact member 612 and is formed within the vicinity of a vertex where the convex member 614 meets the second additional member 616. A second coupling protrusion 640a to be coupled to the second coupling recess is formed on one end of the second inner adjusting member 640, and the other end of the second inner adjusting member 640 has a sixth screw hole (not shown) formed therein and is inserted between the third protrusion 620a and the fourth protrusion 620b. The second inner adjusting member 640 is made of a hard inflexible material.

The second curvature adjusting member 620a, 620b, 630 and 640 includes the second adjusting screw 630 which passes through the second additional member 616 and is inserted into the fourth screw hole, the fifth screw hole and the sixth screw hole. It should be understood that the second adjusting screw 630 includes not only a common screw but also all kinds of adjustment means including a bolt, which can be tightened and loosen by rotation.

In the at least one second curvature adjusting member 620a, 620b, 630 and 640, the other end of the second inner adjusting member 640 is moved between the third protrusion 620a and the fourth protrusion 620b by tightening or loosing the second adjusting screw 630, in response to this, the one end of the second inner adjusting member 640 moves in the opposite direction to the movement direction of the other end. Accordingly, the curvature of the changeable convex curved surface 614a can be adjusted. This is because the second inner adjusting member 640 is made of a hard inflexible material.

In other words, if the other end of the second inner adjusting member 640 moves in a third direction, i.e., toward the third protrusion 620a from the fourth protrusion 620b by tightening or loosing the second adjusting screw 630, the one end of the second inner adjusting member 640 moves in a fourth direction which is opposite to the third direction. Accordingly, the changeable convex curved surface 614a becomes less convex, so that the curvature of the changeable convex curved surface 614a becomes smaller.

On the contrary, if the other end of the second inner adjusting member 640 moves in the fourth direction, i.e., toward the fourth protrusion 620b from the third protrusion 620a, the one end of the second inner adjusting member 640 moves in the third direction which is opposite to the fourth direction. Accordingly, the changeable convex curved surface 614a becomes more convex, so that the curvature of the changeable convex curved surface 614a becomes larger.

Therefore, since it becomes possible to adjust the curvature of the entire or partial changeable convex curved surface 614a by the second adjusting screw 630, the prevention unit 600 can be applied to all the doors having mutually different rotation radii due to the mutually different hinge shafts

In addition, a portion of the convex member 614 and a portion of the second additional member 616 have a corrugated structure 650a and 650b having an elasticity and become elastic by tightening and loosing the second adjusting screw 630. In this case, the curvature of the entire or partial changeable convex curved surface 614a may be more easily adjusted.

Also, an elastic spring (not shown) may be further provided between the third protrusion 620a and the second inner adjusting member 640 or between the fourth protrusion 620b and the second inner adjusting member 640.

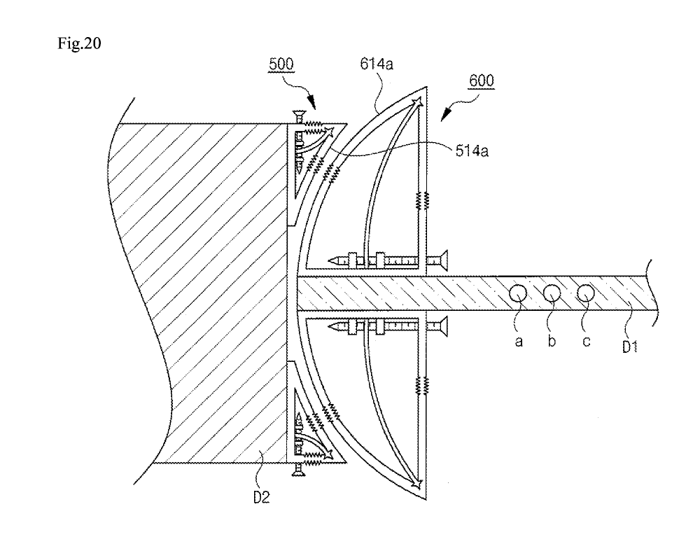

FIGS. 20, 21 and 22 are views showing examples in which the prevention unit according to the third embodiment of the present invention is applied to the doors D1 having various rotation radii.

Here, only an example where the prevention unit according to the third embodiment of the present invention is applied to three doors D1 having different hinge shafts will be described. A case where the prevention unit according to the third embodiment of the present invention is coupled to the door frame D2 adjacent to the hinge shaft of the door D1 and the edge of the door D1 will be described and a case where the prevention unit according to the third embodiment of the present invention is coupled to the door frame D2 adjacent to the door handle of the door D1 and the edge of the door D1 will be omitted.

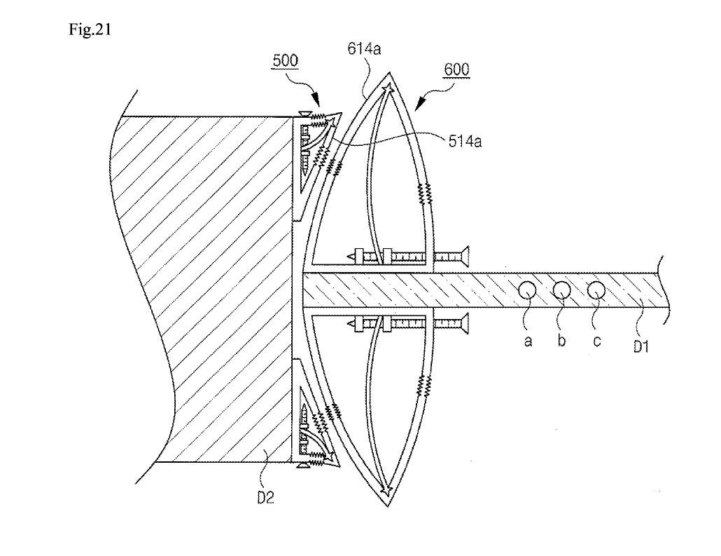

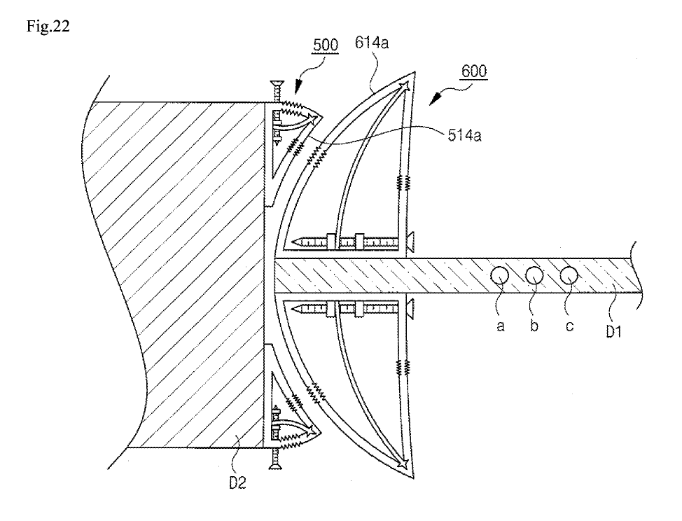

FIG. 20 shows an example in which the door D1 rotates about the second hinge shaft “b” and has the second rotation radius. FIG. 21 shows an example in which the door D1 rotates about the third hinge shaft “c” and has the first rotation radius. FIG. 22 shows an example in which the door D1 rotates about the first hinge shaft “a” and has the third rotation radius. Here, based on the second rotation radius, the first rotation radius is larger than the second rotation radius, and the third rotation radius is less than the second rotation radius.

Although FIGS. 20, 21 and 22 show only the example of the door having the three rotation radii, the present invention can be also applied to a door having different rotation radii.

As shown in FIG. 20, when the door D1 rotates about the second hinge shaft “b” and has the second rotation radius, the changeable concave curved surface 514a of the unit 500 for preventing from being caught in a door frame has a certain curvature and the unit 500 for preventing from being caught in a door frame is coupled to the door frame D2, and the changeable convex curved surface 614a of the unit 600 for preventing from being caught in a door has a certain curvature and the unit 600 for preventing from being caught in a door is coupled to the door D1.

As shown in FIG. 21, when the door D1 rotates about the third hinge shaft “c” and has the first rotation radius larger than the second rotation radius, the curvature of the changeable concave curved surface 514a of the unit 500 for preventing from being caught in a door frame is adjusted to be less than that of FIG. 20 by using the first adjusting screw 530 and then the unit 500 for preventing from being caught in a door frame is coupled to the door frame. Also, the curvature of the changeable convex curved surface 614a of the unit 600 for preventing from being caught in a door is adjusted to be less than that of FIG. 20 by using the second adjusting screw 630 and then the unit 600 for preventing from being caught in a door is coupled to the door.

As shown in FIG. 22, when the door D1 rotates about the first hinge shaft “a” and has the third rotation radius less than the second rotation radius, the curvature of the changeable concave curved surface 514a of the unit 500 for preventing from being caught in a door frame is adjusted to be larger than that of FIG. 20 by using the first adjusting screw 530 and then the unit 500 for preventing from being caught in a door frame is coupled to the door frame. Also, the curvature of the changeable convex curved surface 614a of the unit 600 for preventing from being caught in a door is adjusted to be larger than that of FIG. 20 by using the second adjusting screw 630 and then the unit 600 for preventing from being caught in a door is coupled to the door.

Consequently, when the unit for preventing from being caught is coupled to the door having a larger rotation radius, the curvature of the unit for preventing from being caught is adjusted to be descreased, and when the unit for preventing from being caught is coupled to the door having a smaller rotation radius, the curvature of the unit for preventing from being caught is adjusted to be increased. In this manner, the gap between the unit 500 for preventing from being caught in a door frame and the unit 600 for preventing from being caught in a door can be adjusted.

In the above-described unit for preventing from being caught in a door frame in accordance with the third embodiment of the present invention, it is possible to adjust the curvature of the changeable concave curved surface 514a by adhering the unit 500 for preventing from being caught in a door frame to both the vertical frame adjacent to the hinge shaft of the door and the vertical frame adjacent to the door handle. Also, in the unit 600 for preventing from being caught in a door, it is possible to adjust the curvature of the changeable convex curved surface 614a by adhering the unit 600 for preventing from being caught in a door to both the front and rear edges of the door, which are adjacent to the hinge shaft of the door and the front and rear edges of the door, which are adjacent to the door handle.

The entire unit for preventing from being caught, which has been described in the embodiments of to present invention may be generally made of a soft material, or a portion of the unit may be made of a hard material and another portion of the unit may be made of a soft material. Also, another portion of the unit may be made of a material resistant to sunlight or a metallic material. That is, the unit for preventing from being caught may be made of various materials according to needs.

Although the above embodiments describe the unit for preventing a body part of a user from being caught, which is mounted on the door and the door frame adjacent to the hinge shaft of the door, it is clear that the unit for preventing a body part of a user from being caught can be mounted on the door and the door frame adjacent to the door handle by applying the same principle as the contents of the above-described embodiments.

As described above, according to the embodiments of the present invention, it is possible to prevent or minimize accidents by preventing a body part from being caught between the door frame and the door, and to prevent or minimize the waste of energy leaking through the gap between the door and the door frame. Also, it is also possible to couple the unit to all types of doors having various rotational axes or rotation radii in response to the variation of the rotational axis of the door or to the variation of the rotation radius of the door.

The above-described embodiments are just given as examples with reference to the accompanying drawings for more thorough understanding of the present invention, and thus, are not be construed as limiting the present invention. Also, it will be apparent to those skilled in the art that various changes and modifications may be made without departing from the basic principles of the present invention.

1. A unit for preventing a body part of a user from being caught, which is coupled to a door and a door frame, the door having a structure in which a floor hinge is connected to the lower surface of the door and the upper surface of the door is hinged onto a horizontal frame of the door frame such that the door rotates about a hinge shaft, and the door frame having the horizontal frame and the pair of vertical frames fixed to a wall, the unit comprising:
a unit for preventing a body part of a user from being caught in a door frame, the unit comprising:
a door frame contact surface which is fixed and coupled to the vertical frame of the door frame;
a first concave curved surface which has a first radius of curvature; and
a cylindrical shape which has a triangular cross-section or a quadrangular cross-section having at least one concave side, so that the unit for preventing a body part of a user from being caught in a door frame is coupled such that the first concave curved surface faces a side surface of the door when the door rotates; and
a unit for preventing a body part of a user from being caught in a door, the unit comprising:
a door contact surface which is fixed and coupled to an edge of a front side or rear side of the door;
a first convex curved surface which has a second radius of curvature less than the first radius of curvature; and
a cylindrical shape which has a triangular cross-section or a quadrangular cross-section having at least one convex side, so that the unit for preventing a body part of a user from being caught in a door is coupled such that the vertical frame faces the first convex curved surface when the door rotates.

2. The unit for preventing a body part of a user from being caught of claim 1, wherein the first radius of curvature is the same as or larger by a certain amount than a minimum distance from the hinge shaft to the vertical frame, and wherein the second radius of curvature is the same as or smaller by a certain amount than a rotation radius of the door which rotates about the hinge shaft.

3. The unit for preventing a body part of a user from being caught of claim 1, wherein, when the rotation radius of the door is changed by changing the hinge shaft, the first radius of curvature and the second radius of curvature become larger or smaller in response to the change of the hinge shaft or the change of the rotation radius of the door.

4. The unit for preventing a body part of a user from being caught of claim 1, further comprising a first additional door frame unit which is additionally coupled to the unit for preventing a body part of a user from being caught in a door frame when the hinge shaft is moved and the rotation radius of the door becomes smaller, wherein the first additional door frame unit comprises a first concave curved surface contacting surface and a second concave curved surface, wherein the first concave curved surface contacting surface has a convex curved surface with the first radius of curvature such that the first additional door frame unit contacts and is coupled to the whole or partial first concave curved surface, and wherein the second concave curved surface has a third radius of curvature less than the first radius of curvature, and wherein the first additional door frame unit has a cylindrical shape having a triangular cross-section or a quadrangular cross-section having one concave side and one convex side.

5. The unit for preventing a body part of a user from being caught of claim 4, wherein the first concave curved surface contacting surface comprises a fitting protrusion and the first concave curved surface comprises a fitting recess to which the fitting protrusion is fitted and coupled, so that the first concave curved surface contacting surface is fitted and coupled to the first concave curved surface, or the first concave curved surface contacting surface and the first concave curved surface are adhered to each other by using an adhesive material.

6. The unit for preventing a body part of a user from being caught of claim 5, further comprising a second additional door frame unit which is to be additionally coupled to the first additional door frame unit when the hinge shaft is moved and the rotation radius of the door becomes smaller, wherein the second additional door frame unit comprises a second concave curved surface contacting surface and a third concave curved surface and has a cylindrical shape having a triangular cross-section or a quadrangular cross-section having one concave side and one convex side, wherein the second concave curved surface contacting surface has a convex curved surface with the third radius of curvature such that the second additional door frame unit contacts and is coupled to the whole or partial second concave curved surface, wherein the third concave curved surface has a fourth radius of curvature less than the third radius of curvature, wherein the second concave curved surface contacting surface comprises a fitting protrusion and the second concave curved surface comprises a fitting recess to which the fitting protrusion is fitted and coupled, so that the second concave curved surface contacting surface is fitted and coupled to the second concave curved surface, or the second concave curved surface contacting surface and the second concave curved surface are adhered to each other by using an adhesive material.

7. The unit for preventing a body part of a user from being caught of claim 1, further comprising a first additional door unit which is additionally coupled to the unit for preventing a body part of a user from being caught in a door when the hinge shaft is moved and the rotation radius of the door becomes larger, wherein the first additional door unit comprises a first convex curved surface contacting surface and a second convex curved surface, wherein the first convex curved surface contacting surface has a concave curved surface with the second radius of curvature such that the first additional door unit contacts and is coupled to the whole or partial first convex curved surface, and wherein the second convex curved surface has a fifth radius of curvature larger than the second radius of curvature, and wherein the first additional door unit has a cylindrical shape having a triangular cross-section or a quadrangular cross-section having one convex side and one concave side.

8. The unit for preventing a body part of a user from being caught of claim 7, wherein the first convex curved surface contacting surface comprises a fitting protrusion and the first convex curved surface comprises a fitting recess to which the fitting protrusion is fitted and coupled, so that the first convex curved surface contacting surface is fitted and coupled to the first convex curved surface, or the first convex curved surface contacting surface and the first convex curved surface are adhered to each other by using an adhesive material.

9. The unit for preventing a body part of a user from being caught of claim 8, further comprising a second additional door unit which is additionally coupled to the first additional door unit when the hinge shaft is moved and the rotation radius of the door becomes larger, wherein the second additional door unit comprises a second convex curved surface contacting surface and a third convex curved surface and has a cylindrical shape having a triangular cross-section or a quadrangular cross-section having one convex side and one concave side, wherein the second convex curved surface contacting surface has a concaved curved surface with the fifth radius of curvature such that the second additional door unit contacts and is coupled to the whole or partial second convex curved surface, wherein the third convex curved surface has a sixth radius of curvature larger the fifth radius of curvature, wherein the second convex curved surface contacting surface comprises a fitting protrusion and the second convex curved surface comprises a fitting recess to which the fitting protrusion is fitted and coupled, so that the second convex curved surface contacting surface is fitted and coupled to the second convex curved surface, or the second convex curved surface contacting surface and the second convex curved surface are adhered to each other by using an adhesive material.

10. A unit for preventing a body part of a user from being caught, which is coupled to a door and a door frame, the door having a structure in which a floor hinge is connected to the lower surface of the door and the upper surface of the door is hinged onto a horizontal frame of the door frame such that the door rotates about a hinge shaft, and the door frame having the horizontal frame and the pair of vertical frames fixed to a wall, the unit comprising:
a unit for preventing a body part of a user from being caught in a door frame, the unit comprising:
a door frame contact member which has a door frame contact surface to be coupled to the vertical frame of the door frame;
a concave member which has a changeable concave curved surface having a curvature which is wholly or partially changeable;
a first additional member which has a first additional surface;
an integral cylindrical shape which has a first inner space and a triangular cross-section or a quadrangular cross-section having at least one concave side; and
at least one first curvature adjusting member which is provided in the first inner space in order to change the curvature of the entire or partial changeable concave curved surface when the unit for preventing a body part of a user from being caught in a door frame is applied to a door having a different hinge shaft; and
a unit for preventing a body part of a user from being caught in a door, the unit comprising:
a door contact member which has a door contact surface to be coupled to an edge of a front side or rear side of the door;
a convex member which has a changeable convex curved surface having a curvature which is wholly or partially changeable;
a second additional member which has a second additional surface;
an integral cylindrical shape which has a second inner space and a triangular cross-section or a quadrangular cross-section having at least one convex side; and
at least one second curvature adjusting member which is provided in the second inner space in order to change the curvature of the entire or partial changeable convex curved surface when the unit for preventing a body part of a user from being caught in a door frame is applied to a door having a different hinge shaft.

11. The unit for preventing a body part of a user from being caught of claim 10, wherein the door frame contact member, the concave member, the first additional member, the door contact member, the convex member and the second additional member are made of a soft flexible material, or wherein the door frame contact member and the door contact member are made of a hard material, and the concave member, the first additional member, the convex member and the second additional member are made of a soft material.

12. The unit for preventing a body part of a user from being caught of claim 11, wherein the at least one first curvature adjusting member comprises: a first protrusion which is formed on an inner surface of the door frame contact member forming the first inner space and has a first screw hole formed therein; a second protrusion which is formed on the inner surface of the door frame contact member, is spaced apart from the first protrusion by a certain distance, and has a second screw hole formed therein; a first coupling recess which faces the inner surface of the door frame contact member and is formed within the vicinity of a vertex where the concave member meets the first additional member; a first inner adjusting member of which one end has a first coupling protrusion to be coupled to the first coupling recess and of which the other end has a third screw hole and is inserted between the first protrusion and the second protrusion, wherein the first inner adjusting member is made of a hard inflexible material; and a first adjusting screw which passes through the first additional member and is inserted into the first screw hole, the second screw hole and the third screw hole, wherein the other end of the first inner adjusting member is moved between the first protrusion and the second protrusion by tightening or loosing the first adjusting screw, in response to this, the one end of the first inner adjusting member moves in the opposite direction to the movement direction of the other end, so that the curvature of the changeable concave curved surface is adjusted.

13. The unit for preventing a body part of a user from being caught of claim 11, wherein the at least one second curvature adjusting member comprises: a third protrusion which is formed on an inner surface of the door contact member forming the second inner space and has a fourth screw hole formed therein; a fourth protrusion which is formed on the inner surface of the door contact member, is spaced apart from the third protrusion by a certain distance, and has a fifth screw hole formed therein; a second coupling recess which faces the inner surface of the door contact member and is formed within the vicinity of a vertex where the convex member meets the second additional member; a second inner adjusting member of which one end has a second coupling protrusion to be coupled to the second coupling recess and of which the other end has a sixth screw hole and is inserted between the third protrusion and the fourth protrusion, wherein the second inner adjusting member is made of a hard inflexible material; and a second adjusting screw which passes through the second additional surface and is inserted into the fourth screw hole, the fifth screw hole and the sixth screw hole, wherein the other end of the second inner adjusting member is moved between the third protrusion and the fourth protrusion by tightening or loosing the second adjusting screw, in response to this, the one end of the second inner adjusting member moves in the opposite direction to the movement direction of the other end, so that the curvature of the changeable concave curved surface is adjusted.

14. The unit for preventing a body part of a user from being caught of claim 12, wherein a portion of the concave member and a portion of the first additional member have a corrugated structure having an elasticity and become elastic by tightening and loosing the first adjusting screw.

15. The unit for preventing a body part of a user from being caught of claim 12, wherein an elastic spring is further provided between the first protrusion and the first inner adjusting member or between the second protrusion and the first inner adjusting member.

16. The unit for preventing a body part of a user from being caught of claim 13, wherein a portion of the convex member and a portion of the second additional surface have a corrugated structure having an elasticity and become elastic by tightening and loosing the second adjusting screw.

17. The unit for preventing a body part of a user from being caught of claim 13, wherein an elastic spring is further provided between the third protrusion and the second inner adjusting member or between the fourth protrusion and the second inner adjusting member.
